(19) United States
(12) Patent Application Publication
(10) Pub. No.: US 2020/0320830 A1
(43) Pub. Date: Oct. 8, 2020

(54) MASSIVELY MULTIPLAYER WAGERING GAME SYSTEM

(71) Applicant: Sak Mahasuverachai, Bangkok (TH)

(72) Inventor: Sak Mahasuverachai, Bangkok (TH)

(21) Appl. No.: 16/820,065

(22) Filed: Mar. 16, 2020

Related U.S. Application Data
(63) Continuation of application No. 15/576,548, filed on Nov. 22, 2017.
(60) Provisional application No. 62/166,182, filed on May 26, 2015.

(51) Int. Cl. G07F 17/32; G06Q 50/34

(52) U.S. Cl. CPC G07F 17/3276; G07F 17/3293; G07F 17/3279; G07F 17/3288; G07F 17/3272; G07F 17/3223; G07F 17/3237; G06Q 50/34

(57) ABSTRACT

The present disclosure provides a system and method for operating a multiplayer (e.g., massively multiplayer) wagering game system. The system groups players based on, e.g., actions of the players (such as a wager amount or an election of the player), the player's hand, or a combination thereof, and determine rankings of the players in each respective groups. The wagering game system allows traditional card games to be played by an unlimited number of players.

### RELATED APPLICATIONS

The present application claims priority to and the benefit of U.S. Application No. 62/166,182, titled “Massively Multiplayer Wagering Game System,” filed on May 26, 2015, which is hereby incorporated by reference in its entirety.

### BACKGROUND

In the gambling industry, games can be classified into two general types: one in which individual players play against the house (“player-versus-house” type game) and one in which the players compete against other players (“player-versus-player” type game). Examples of player-versus-house type games include slot machines, Blackjack, roulette, and games of the like. Typically, there is no direct interaction with other players.

Player-versus-player type games includes games such as poker. This type of game is favored by certain players because the chance of winning is the same for each player. In addition, each player's game play and decision can directly affect the game play and decision of other players, thereby improving the player's chance of winning. These factors, among others, contribute to the popularity of player-versus-player games.

Player-versus-player games can be even more popular if more players can compete in a given game. However, traditional player-versus-player type games are limited in the number of players that can play in a given game. Adding card decks, game tokens, or game pieces would result in duplicate cards in a player's hand. This negatively affects the card combinations that can be generated, thereby unpredictably changing the odds of the game. In addition, more players increase the game time, negatively affecting the enjoyment and experience of the players. Poker, for example, allows player to exchange cards in the player's hand as part of the gameplay. Introducing a large number of players into the game would increase the time for such card exchange.

There is a benefit for more players to effectively play against one another in traditional player-versus-player games such as poker. The present disclosure describes and provides explicit exemplification of systems that provide such games.

### SUMMARY

In general overview, the present technology provides a massively multiplayer wagering game system that enables a large numbers of players to play against one another in traditional player-versus-player types of games—such as poker card games, and the like. Among other things, the present technology allows an unlimited number of players to play in a massively multiplayer wagering game using traditional player-versus-player types of rules while preserving the gameplay aspects of the game. In particular, the Examples included herein demonstrate, among other things, that massively multiplayer card games based on draw poker (e.g., “five-card draw”), stud poker (e.g., “five-card stud” and “seven-card stud”), and community card poker (e.g., “Texas hold 'em” and “Omaha hold 'em”), can be played with unlimited numbers of players. Still further, the present exemplification demonstrates that other types of card games, such as Blackjack, and dice games, may be played with unlimited numbers of players.

To enable greater numbers of players to play against one another in traditional player-versus-player type games, the present system dynamically segments the players, during game play, into smaller groups of players based, e.g., on the actions of the players or the player's hand. The players can then compete against players in the subgroup, and win within their respective subgroups. Consequently, the number of players can be increased in a significant manner, up to infinite players. The present technology preserves the game play that makes such games popular.

In some embodiment, the segmentation of the players is based on the actions of the players. Players are thus incentivize to make actions that are consistent with their own valuation of the strength of their hands. In some embodiments, the actions are based on the wager amount placed by the player. In addition or alternative to, the segmentation are based on an election of game rules by the player during the game play. Players having made similar elections can be grouped together. The player segmentation adds a new aspect to the game play that employs both luck and skill as a foundation to winning. This modification is consistent with the appeal of the game.

In other embodiments, the segmentation is based purely on luck (for example, based solely on the hands of the players). In such implementations, like-hands may be grouped together into categories from which one or more winners in each respective categories are selected.

To allow greater numbers of players to play against one another in certain traditional player-versus-player type games, the present technology addresses the issue of duplicate game pieces. Firstly, the present technology allows for multiple winners in the event of a tie. That is, for a given subgroup, in the event that the winning hand appears among multiple players, these players would be the winners for the subgroup and share the payout.

For certain types of card games, it is found that duplicate community cards are particularly problematic. That is, cards that are common, or used, by all the players. To address this, the present technology maintains a personal card deck for each individual player from which each player hand is drawn. The system then redraws a substitute card from the personal card deck of a given player's hand if the community card matches an existing card in the player's hand. This modification allows players to be added while ensuring that unique combinations of hands (e.g., Poker hands) are maintained, thereby allowing traditional ranking systems, such as Poker rules, to be used. Because the present technology displays the game pieces to each player via a user interface specific to the player, this adaptation does not affect the game play for other players.

The increased number of players beneficially allows a larger payout pot to be created. This aspect of the present system creates incentives for players to play the present game as compared to other games. In addition or alternative to, with increased number of players, the present game allows players to play with smaller wagers, while still allowing a sufficiently large payout to be accumulated as an incentive to play. Specifically exemplified herein is a massively multiplayer wagering game system to be employed in a lottery system.

In some embodiments, the present technology is used to host a lottery game using a massively multiplayer wagering game.

The present invention further demonstrates a process to create new player-versus-player types of games that combines game elements/game players from existing player-versus-player types of games. The Examples included herein demonstrate, among other things, that other types of player-versus-player types of games may be created from such combinations.

In one aspect, a computer-implemented method for operating a multiplayer (e.g., massively multiplayer) wagering game system is disclosed. The method includes receiving, over a network, by a processor of a first computing device (e.g., a server), a plurality of player submissions from a plurality of computing devices associated with players in a multiplayer wagering game, wherein each of the player submissions includes a member selected from the group consisting of (a) an incremental wager to the wager pot, and (b) an election of a payout condition associated with the multiplayer wagering game; grouping, by the processor, each player of the multiplayer wagering game into one of a plurality of playable subgroups within the multiplayer wagering game based on the player submission of the respective player (e.g., wherein each subgroup has the same second wager, the same election of the payout condition, or the same aggregated wager of each respective player); determining, by the processor, ranks of the players, in each of the plurality of pre-defined playable subgroups, by comparing the respective token pattern associated with each player to the token patterns of other players in the same playable subgroup; and causing, by the processor, one or more payouts based on the rank of the players within each playable subgroup (e.g., wherein the payout is based on the global wager pot).

In some embodiments, the method further includes receiving, by the processor, a plurality of wager submissions (e.g., antes) for the multiplayer wagering game, wherein each wager submission of the plurality of wager submissions is associated with a given player; and adding, by the processor, for each of the wager submissions, a player associated with the submission to the multiplayer wagering game (e.g., adding a player identifier associated with the submission to a list of active of players). In some embodiments, the wager submission of each player is the same among all the players in a given game. In other embodiments, the wager submissions of the players are different.

In some embodiments, the method includes assigning, by the processor (e.g., via a random or pseudorandom process), to each player of the multiplayer wagering game, a set of game pieces (e.g., cards) from a collection of game pieces specific to each player (e.g., a personal card deck specific to each player), wherein the assigned set of game pieces (e.g., player hand) form one or more token patterns (e.g., Poker hands, such as “straight flush”, “four-of-a-kind”, “full house”, “three-of-a-kind”, “straight”, “flush”, “pairs’, etc.) according to a ranking system.

In some embodiments, the method further includes assigning, by the processor (e.g., via a random or pseudorandom process), a set of community pieces (e.g., cards) from a collection of community pieces common to all the players (e.g., a community card deck specific either to the multiplayer wagering game or the plurality of pre-defined playable subgroups), wherein the assigned set of game pieces specific to a given player and the set of community pieces, collectively, form the one or more predefined combinations (e.g., Poker hands, such as “straight flush”, “four-of-a-kind”, “full house”, “three-of-a-kind”, “straight”, “flush”, “pairs’, etc.) of the plurality arrangements defined within the ranking system; responsive to the assignment of the community pieces, determining, by the processor, for each player if any of the assigned game pieces specific to the respective player matches (e.g., having the same suite and rank) any of the community pieces; and responsive to each matched game piece and community piece, replacing, by the processor (e.g., via a random or pseudorandom process), the matched game piece of the player with a substitute game piece selected from the collection of game pieces specific to the player.

In some embodiments, the collection of community pieces is common to all players in the multiplayer wagering game. In some embodiments, the collection of community pieces is common to all players in a given playable subgroup of the plurality of pre-defined playable subgroups.

In some embodiments, the ranking system is based on poker hand ranks.

In some embodiments, the multiplayer wagering game is based on poker (e.g., a member selected from the group consisting of “five card draw poker”, “seven card draw poker”, “Texas hold 'em poker”, “Omaha hold 'em poker”, “five-card stud poker”, and “seven-card stud poker”).

In another aspect, a method for operating a wagering game system (e.g., “Derivative Blackjack”) is described. The method includes, for each player of the multiplayer wagering game, during the multiplayer wagering game: receiving over a network, by a processor of a first computing devices (e.g., a server), a first player submission from a second computing device associated with a given player, wherein the first player submission includes a wager by the given player to a global wager pot associated with the multiplayer wagering game; assigning, by the processor, (e.g., via a random or pseudorandom process) to the given player, a set of first game tokens (e.g., a card); grouping, by the processor, the given players into a subgroup with other players of the multiplayer wagering game based, in part, on a combination form of the set of first game tokens (e.g., “21”, “19” and “20”, “17” and “18”); assigning, by the processor, (e.g., via a random or pseudorandom process) to the given player, a set of second game tokens (e.g., a card); comparing, by the processor, the combination sets of assigned set of second game tokens of the given player to the combination sets of other players in the group; and causing, by the processor, one or more payouts based on the rank of the players within the respective subgroup (e.g., wherein the payout is based on the global wager pot).

In some embodiments, the set of tokens comprises a set of members selected from the group consisting of playing cards and dice.

In another aspect, a massively multiplayer wagering game system is described. The system comprises a network; a processor; and a memory having instructions stored thereon, wherein the instructions, when executed by the processor, cause the processor to provide, via the network, a player-versus-player game (e.g., a card game such as Poker) to a plurality of computing devices associated with plurality of players, wherein the player-versus-player game aggregates players in the game into groups such that game is playable by an infinite number of players. In some embodiments, the grouping is based on a member selected from the group consisting of i) a wager placed by the player (e.g., at a given stage of the game), ii) total wager placed by the player, e.g., to the player's individual pots, iii) a pre-defined combination formed with the player's hand, and iv) an election of payout conditions made by the player.

In some embodiments, the system maintains: a) a community means (e.g., namely a collection of game tokens, such as cards) common to all of the players in the multiplayer wagering game and b) for each player of the card game, a personal means (e.g., namely a collection of game tokens or pieces, such as cards) such that the system maintains N number of personal means for a given game, wherein N is the number of players.

In another aspect, a system for operating a wagering game system (e.g., classic poker) is described. The system includes a network; a processor; and a memory having instructions thereon, wherein the instructions, when executed by the processor, cause the processor to: for each player of the multiplayer wagering game, during the multiplayer wagering game: receive a plurality of player submissions from a plurality of computing devices associated with players in a multiplayer wagering game, wherein each of the player submissions includes a member selected from the group consisting of (a) an incremental wager to the wager pot (e.g., wherein the incremental wager are the same among all the players, e.g., an ante), (b) a conditional wager to the wager pot (e.g., wherein the conditional wager is specific to some of the members, e.g., a blind wager), and (c) an election of a payout condition associated with the multiplayer wagering game; group each player of the multiplayer wagering game into one of a plurality of playable subgroups within the multiplayer wagering game based on an individual pot (e.g., a quantity of the pot) associated with each respective player and/or the player submission of the respective player (e.g., wherein each subgroup has the same wager, the same election of the payout condition, or the same aggregated wager of each respective player); determine ranks of the players, in each of the plurality of pre-defined playable subgroups, by comparing the respective token pattern associated with each player to the token patterns of other players in the same playable subgroup; and cause one or more payouts based on the rank of the players within each playable subgroup (e.g., wherein the payout is based on the global wager pot).

In some embodiments, the instructions, when executed by the processor, cause the processor to: receive a plurality of wager submissions (e.g., antes) for the multiplayer wagering game, wherein each wager submission of the plurality of wager submissions is associated with a given player; and add for each of the wager submissions, a player associated with the submission to the multiplayer wagering game (e.g., adding a player identifier associated with the submission to a list of active of players). In some embodiments, the wager submission of each player is the same among all the players in a given game. In other embodiments, the wager submissions of the players are different.

In some embodiments, the instructions, when executed by the processor, cause the processor to: assign (e.g., via a random or pseudorandom process), to each player of the multiplayer wagering game, a set of game pieces (e.g., cards) from a collection of game pieces specific to each player (e.g., a personal card deck specific to each player), wherein the assigned set of game pieces (e.g., player hand) form one or more token patterns (e.g., Poker hands, such as “straight flush”, “four-of-a-kind”, “full house”, “three-of-a-kind”, “straight”, “flush”, “pairs’, etc.) according to a ranking system.

In some embodiments, the instructions, when executed by the processor, cause the processor to: assign (e.g., via a random or pseudorandom process), a set of community pieces (e.g., cards) from a collection of community pieces common to all the players (e.g., a community card deck specific either to the multiplayer wagering game or the plurality of pre-defined playable subgroups), wherein the assigned set of game pieces specific to a given player and the set of community pieces, collectively, form the one or more predefined combinations (e.g., Poker hands, such as “straight flush”, “four-of-a-kind”, “full house”, “three-of-a-kind”, “straight”, “flush”, “pairs’, etc.) of the plurality arrangements defined within the ranking system; responsive to the assignment of the community pieces, determine for each player if any of the assigned game pieces specific to the respective player matches (e.g., having the same suite and rank) any of the community pieces; and responsive to each matched game piece and community piece, replace (e.g., via a random or pseudorandom process), the matched game piece of the player with a substitute game piece selected from the collection of game pieces specific to the player.

In some embodiments, the collection of community pieces is common to all players in the multiplayer wagering game.

In some embodiments, the collection of community pieces is common to all players in a given playable subgroup of the plurality of pre-defined playable subgroups.

In some embodiments, the ranking system is based on poker hand ranks.

In some embodiments, the multiplayer wagering game is based on poker (e.g., a member selected from the group consisting of “five card draw” poker, “seven card draw poker”, “Texas hold 'em poker”, “Omaha hold 'em poker”, “five-card stud poker”, and “seven-card stud poker”).

In another aspect, a system for operating a wagering game system (e.g., “Derivative Blackjack”) is described. The system includes a network; a processor; and a memory having instructions stored thereon, wherein the instructions, when executed by the processor, further cause the processor to: for each player of the multiplayer wagering game, during the multiplayer wagering game: receive, over the network, a first player submission from a second computing device associated with a given player, wherein the first player submission includes a wager by the given player to a global wager pot associated with the multiplayer wagering game; assign (e.g., via a random or pseudorandom process) to the given player, a set of first game tokens (e.g., a card); group the given players into a subgroup with other players of the multiplayer wagering game based, in part, on a combination form of the set of first game tokens (e.g., “21”, “19” and “20”, “17” and “18”); assign (e.g., via a random or pseudorandom process) to the given player, a set of second game tokens (e.g., a card); compare the combination sets of assigned set of second game tokens of the given player to the combination sets of other players in the group; and cause one or more payouts based on the rank of the players within the respective subgroup (e.g., wherein the payout is based on the global wager pot).

In some embodiments, the set of tokens comprise a set of members selected from the group consisting of playing cards and dice.

### BRIEF DESCRIPTION OF THE FIGURES

The foregoing and other objects, aspects, features, and advantages of the present disclosure will become more apparent and better understood by referring to the following description taken in conjunction with the accompanying drawings, in which:

FIG. 1 depicts a diagram of a multiplayer (e.g., massively multiplayer) wagering game system, in accordance with an example embodiment of the present disclosure.

FIG. 2 depicts a schematic of a multiplayer (e.g., massively multiplayer) wagering game system, in accordance with an example embodiment of the present disclosure.

FIG. 3 depicts a block diagram illustrating a method for operating a multiplayer wagering game system, in accordance with an example embodiment of the present disclosure.

FIG. 4A depicts processing modules of multiplayer wagering game system, in accordance with an example embodiment of the present disclosure.

FIG. 4B depicts processing modules of multiplayer wagering game system, in accordance with an example embodiment of the present disclosure.

FIG. 4C depicts processing modules of multiplayer wagering game system, in accordance with an example embodiment of the present disclosure.

FIG. 4D depicts processing modules of multiplayer wagering game system, in accordance with an example embodiment of the present disclosure.

FIG. 5A depicts processes of grouping players into sub-groups, in accordance with an example embodiment of the present disclosure.

FIG. 5B depicts processes of grouping players into sub-groups, in accordance with an example embodiment of the present disclosure.

FIG. 5C depicts processes of grouping players into sub-groups, in accordance with an example embodiment of the present disclosure.

FIG. 6 depicts an exemplary multiplayer wagering game based on classic poker, in accordance with an example embodiment of the present disclosure.

FIG. 7 depicts an exemplary multiplayer wagering game based on “Texas hold 'em poker,” in accordance with an example embodiment of the present disclosure.

FIG. 8 depicts an exemplary multiplayer wagering game based on Derivative Poker, in accordance with an example embodiment of the present disclosure.

FIG. 9 depicts an exemplary multiplayer wagering game based on Derivative Blackjack, in accordance with an example embodiment of the present disclosure.

FIG. 10 depicts an exemplary multiplayer wagering game based on rolling-dice, in accordance with an example embodiment of the present disclosure.

FIG. 11 depicts a block diagram of an exemplary cloud computing environment, for use in illustrative embodiments of the invention.

FIG. 12 depicts a block diagram of an example computing device and an example mobile computing device, for use in illustrative embodiments of the invention.

The features and advantages of the present disclosure will become more apparent from the detailed description set forth below when taken in conjunction with the drawings, in which like reference characters identify corresponding elements throughout. In the drawings, like reference numbers generally indicate identical, functionally similar, and/or structurally similar elements.

### DETAILED DESCRIPTION

It is contemplated that methods, systems, and processes described herein encompass variations and adaptations developed using information from the embodiments described herein.

Throughout the description, where systems and compositions are described as having, including, or comprising specific components, or where processes and methods are described as having, including, or comprising specific steps, it is contemplated that, additionally, there are systems and compositions of the present embodiment that consist essentially of, or consist of, the recited components, and that there are processes and methods of the present embodiment that consist essentially of, or consist of, the recited processing steps.

The mention herein of any publication, for example, in the Background section (or elsewhere), is not an admission that the publication serves as prior art with respect to any of the claims presented herein. The Background section is presented for purposes of clarity and is not meant as a description of prior art with respect to any claim.

Headers are used herein to aid the reader and are not meant to limit the interpretation of the subject matter described.

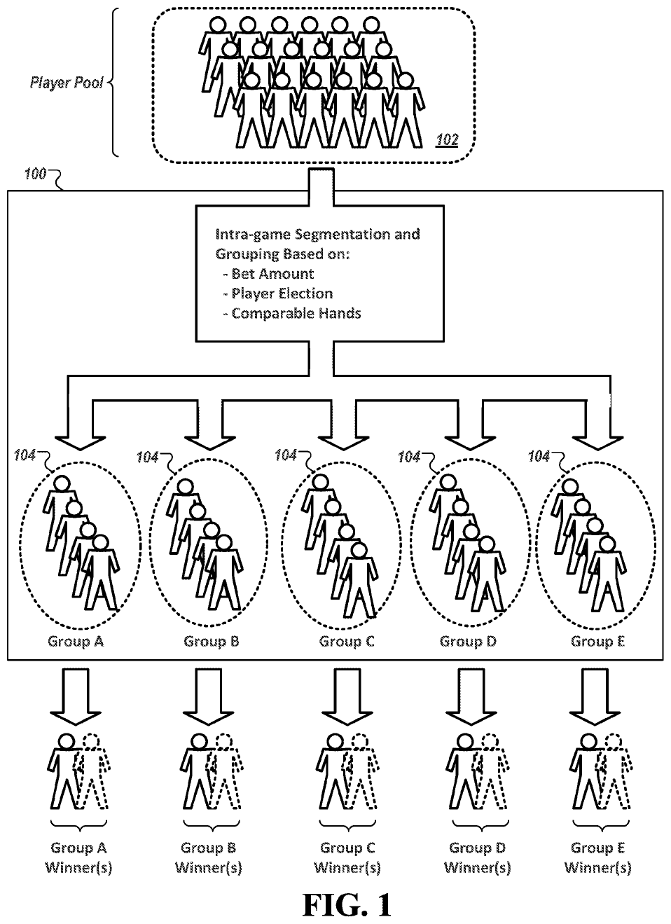

FIG. 1 depicts a diagram of a multiplayer (e.g., massively multiplayer) wagering game system, in accordance with an example embodiment. The multiplayer wagering game system 100 executes a multiplayer wagering game that allows greater numbers of players to play against one another in traditional player-versus-player types of games. The multiplayer wagering game system 100 initiates a multiplayer wagering game with a plurality of players 102. The players 102 of the multiplayer wagering game are determined based on a wager placed by each player 102 at the beginning of the multiplayer wagering game. During the game, the multiplayer wagering game system 100 then dynamically segments the players into smaller groups of players 104 based on the actions of the players. The players can then compete against players in the subgroup 104, and win within their respective subgroups.

In some embodiments, the number of subgroups is defined at the initiation of beginning of the multiplayer wagering game. That is, the number of subgroups are fixed at the beginning of the game. The segmentation improves the chances of the player in winning in the multiplayer wagering game. Alternatively, the multiplayer wagering game system 100 may allow any numbers of players for each subgroup.

When the number of players is increased, the chance of winning is lowered because the likelihood of another player having a better hand is increased. For example, in poker, if a player has a “Full House” in the player's hand, which is a fairly good hand with a very high chance of winning (1:693 occurrence for 5-hand poker game), the player would have a very high expectation of victory. However, if the player is playing against 100,000 other players, then a “Full House” would likely never win as there is a higher likelihood that other players would also have a “Full House” or better. By segmenting the players into subgroups based on the players action, such as wager amount (i.e., an additional wager amount to the initial wager), the multiplayer wagering game system 100 gives the player an opportunity to evaluate the strength of their hand and then to place a wager amount to give him or her the best chance of winning. This aspect of the game provides an element of luck and skill for the players. That is, a player with a good hand may not necessarily win if the player underestimates the chance of other players having similar or stronger hands.

In addition or alternative to, the multiplayer wagering game system 100, in some embodiments, allows segmentation of the players to be based on an election of game rules by the player. The election may be used, by the system, to group a given player with other players of similar elections in which a specific set of rules is used to evaluate the winner within the group. In certain embodiments, the game system allows players to elect, e.g., if certain conditions are satisfied (e.g., the player having a certain game hand), either a payout and/or placement into a group to compete for a higher payout.

In some embodiments, the multiplayer wagering game system 100 may form nested groups within subgroups that have been segmented. The nesting may be based on an action of the player, such as an further additional wager amount, or an election of game rules.

In some embodiments, the multiplayer game is based on traditional player-versus-player types of card games such as poker. Examples of such poker games include draw poker (e.g., “five-card draw”), stud poker (e.g., “five-card stud” and “seven-card stud”), and community card poker (e.g., “Texas hold 'em” and “Omaha hold 'em”). In addition or alternative to, the multiplayer game is a derivative game that combines game elements from existing player-versus-player types of games to allow users to win based on certain game rules associated with a given existing player-versus-player type game once the game has started.

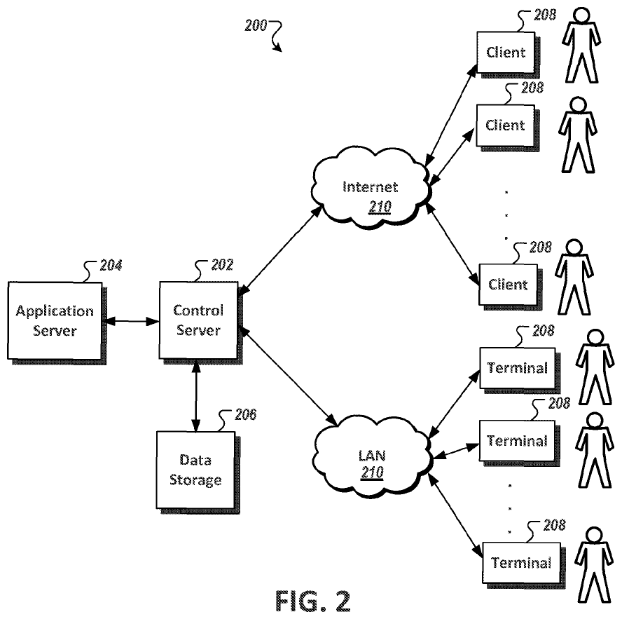

FIG. 2 depicts a schematic of a multiplayer (e.g., massively multiplayer) wagering game system 200, in accordance with an example embodiment. The wagering game system 200 includes a control server 202 operatively and communicatively coupled, through one or more networks 210, to a vast number of wagering game clients 208. The wagering game clients 208 operate a game application that provides an user interface for a given player to access the multiplayer wagering game.

Once logged into a user account associated with a player identifier, the user can elect, within the wagering game client 208, to join a game session for a scheduled multiplayer game. In some embodiments, the multiplayer game has a pre-defined set of game tables (e.g., where each table corresponds to a group).

The control server 202 includes, in some embodiments, one or more servers to share the load associated with the connectivity of the wagering game clients 208. The wagering game clients may operate on a general computing device, shown as a “client 208”, or a wagering game terminal, shown as a “terminal 108.” The control server 202 may control the actions of the game and coordinate the game actions with one or more application servers 204 and data storage servers 206. The servers may be logical/virtual or physical computing devices.

In some embodiments, the wagering game client 208 forms a Web application that is executable from a Web browser, or the like, of the computing device. In other embodiments, the client 208 includes a client application or a browser plug-in that is installed on the computing device. Examples of computing devices operating the wagering game client 208 include, but are not limited to, a mobile device, smart phone, cellphone, laptop, tablet, desktop, game console, and other electronic devices that include a graphical user interface and can be operatively linked to the game network to create the massively-connected system of gaming devices. Other examples of computing devices operating the wagering game client 208 include, but are not limited to, slot machines, video slot machines, video gaming machines, and other types of gaming systems as used in gambling and wagering establishment or facility, such as a Casino. In some embodiments, the computing devices include an electronic graphical user interface and/or electromechanical inputs (e.g., buttons or lever) to capture inputs from the player. In other implementations, the mobile device further includes sensors (such as an capacitive touchscreen input, microphone, camera, an accelerometer, and/or a gyroscopic sensor) configured to interpret the readings of the sensors to detect player actions mapped to such sensor readings.

The networks 210 may include, but not limited to, the Internet, a Wide-Area Network, or a Local Area Network. In some embodiments, a persistent network connection is maintained between the wagering game client 208 and the control server 202 after the wagering game client 208 is authenticated. The wagering game client 208 allows players to simultaneously access the game in real-time along with the other players. In some embodiments, the wagering game clients 208 operatively connect to the control server 202 via a secured and closed local area network. In other embodiments, the wagering game clients 208 operatively connect to and/or communicate with the control server 202 using encrypted messages and protocols (e.g., HTTPS, SSL/TLS) within a unsecured and open network 210.

### Game Processes

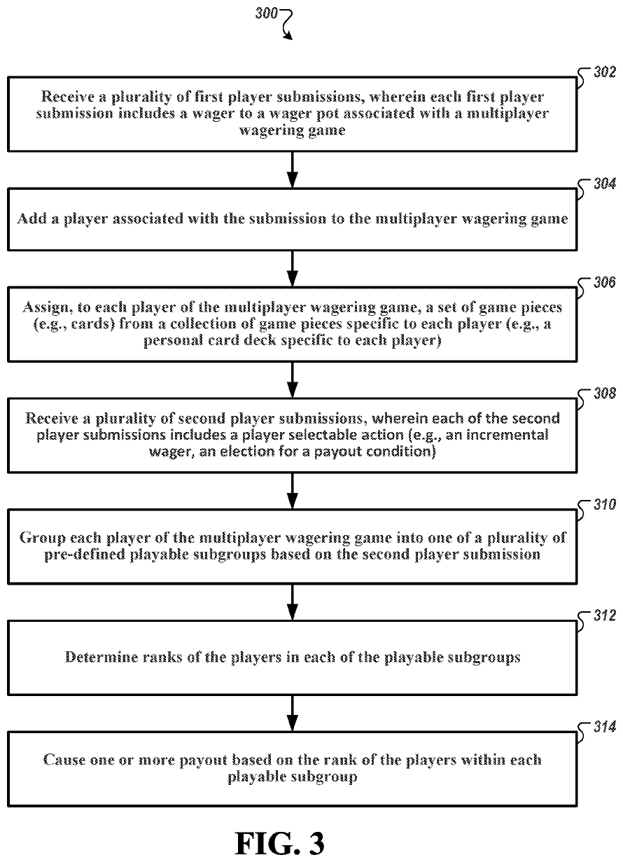

FIG. 3 depicts a block diagram illustrating a method 300 for operating a multiplayer wagering game system, in accordance with an example embodiment.

The multiplayer wagering game initiates with a pre-game stage. During this stage, the multiplayer wagering game system 100 accepts registration from players 102 to participate in the multiplayer wagering game. The registration defines the number of players in a given multiplayer game. Players may not join a game after the registration phase is completed thereby preventing players from joining in between the game. The registration, in some implementations, includes an identifier of the player and an identifier of the respective multiplayer game to join. In some embodiments, the multiplayer wagering game includes a registration fee (or an ante or blind wager) to join a multiplayer game. Once the registration period has elapsed, the game will start.

Upon initiation of the game, the multiplayer wagering game system 100 prompts each player to place a wager to a pot, or the like, associated with the multiplayer wagering game (step 302). In some embodiments, the wager is required from all registered players and is a fixed amount that is applied to a jackpot, a global pot, or the like, associated with the given multiplayer wagering game. In other embodiments, the system requests a wager from a portion of a players (e.g., similar to a bind wager). For example, the system may determine the one or more players required to pay the blind wager based on a selection of the player via a pseudorandom or random process. In other examples, the system may alternatively require the players to pay a blind wager based on the player's registrant number (e.g., odd/even numbers, the last 25% of the registrant, or the last 50% of the registrant). In certain embodiments, the wager to the pot is collected, by the multiplayer wagering game system during the registration phase.

The multiplayer wagering game provides an allotted time for the player to take the action of submitting the wager. The time, in some implementations, may range between 30 seconds and 10 minutes (e.g., 30 seconds, 1 minute, 2 minute, 3 minute, 4 minute, 5 minute, 6 minute, 7 minute, 8 minute, 9 minute, and 10 minutes). In response to receiving the wager, the multiplayer wagering game system 100 adds each player having submitted the wager to a list of active players of the multiplayer wagering game (step 304). In other embodiments, the multiplayer wagering game system keeps the player in the list of active players and removes players that did not submit a wager. The wager, in some implementations, are a part of a player submission. The player submission, in some implementations, includes an identifier of the player (e.g., player name, identification number, or member number, or the like) and a time stamp. The player submission is preferably encrypted.

Subsequently, the multiplayer wagering game system 100 assigns a set of game tokens (e.g., a deck of cards), to each player that has submitted a wager, from a collection of game tokens specific to that player (step 306). A player that does not place a wager, within the allotted time, is not assigned a set of game tokens. In some embodiments, the player is allowed to view the game play as an observer. In other embodiments, the player is removed from the multiplayer wagering game (e.g., directed back to the game login screen).

The set of game tokens assigned to each player is taken from a collection of game tokens specific to each player. The collection is a personal set such that tokens is assigned to a single player. The assignment is based, in some implementations, on a pseudorandom or random process, or the like. The collection of game tokens specific to each player is also referred to as a personal deck or a player's deck. In some embodiments, the personal deck of a player includes set of tokens (e.g., cards) in which each token has a unique rank (e.g., 1, 2, 3, 4, 5, 6, 9, 10, J, Q, K, A) and suit (e.g., hearts, clubs, spades, and diamonds) combination.

Because the game tokens assigned to each player are taken from a collection of tokens specific to the player, duplicate tokens do not occur in a given player's hand during game play. To this end, the present multiplayer wagering game can employ existing ranking systems of traditional card games (e.g., existing poker rules, e.g., “royal-flush”, “straight-flush”, “four-of-a-kind”, “full-house”, “flush”, “straight”, “three-of-a-kind”, pairs, etc.). In addition, the collection increases the numbers the game tokens in the multiplayer wagering game. Consequently, an unlimited number of players can play and/or compete in a player-versus-player type game.

In certain multiplayer wagering games that use community tokens (e.g., “Texas hold 'em poker”), the multiplayer wagering game system substitutes each duplicated community token (i.e., that matching a player's personal token) with a new token from the collection of tokens specific to the player. A community token is applied to more than one player. Because the game play of the multiplayer game is provided through a user interface specific to each player, the multiplayer wagering game system can display different community tokens to each player. This feature does not negatively impact the game play because community tokens are employed, in such games, in combination with the set of personal game tokens to create patterns used in the ranking of the players according to a pre-defined ranking system. The classification or designation of a token as being either a community or a personal token is irrelevant, in some embodiments, to determining the ranks of the player's hand. The multiplayer wagering game system maintains a single set of community tokens, e.g., for each multiplayer wagering game. The set of community tokens preferably has the same number of tokens and types of tokens as each personal set of tokens specific to a player.

In certain embodiments, the multiplayer wagering game system assigns, to each player, tokens according to traditional game rules (e.g., one token, three tokens, five tokens, or seven tokens). For example, the number of assigned cards may correspond to a traditional player-versus-player type card game, such as five card draw poker”, “seven card draw poker”, “Texas hold 'em poker”, “Omaha hold 'em poker”, “five-card stud poker”, and “seven-card stud poker”.

In some embodiments, as non-limiting examples, the game tokens are represented as playing cards in which each card has a suit (e.g., hearts, clubs, spades, and diamonds) and a rank (e.g., 1, 2, 3, 4, 5, 6, 9, 10, J, Q, K, A). In other embodiments, the game tokens include a set of game dice. The game dice may have at least 2 faces. In other embodiments, the game tokens are represented as dominos. In other embodiments, the game tokens are represented as Mahjong tiles.

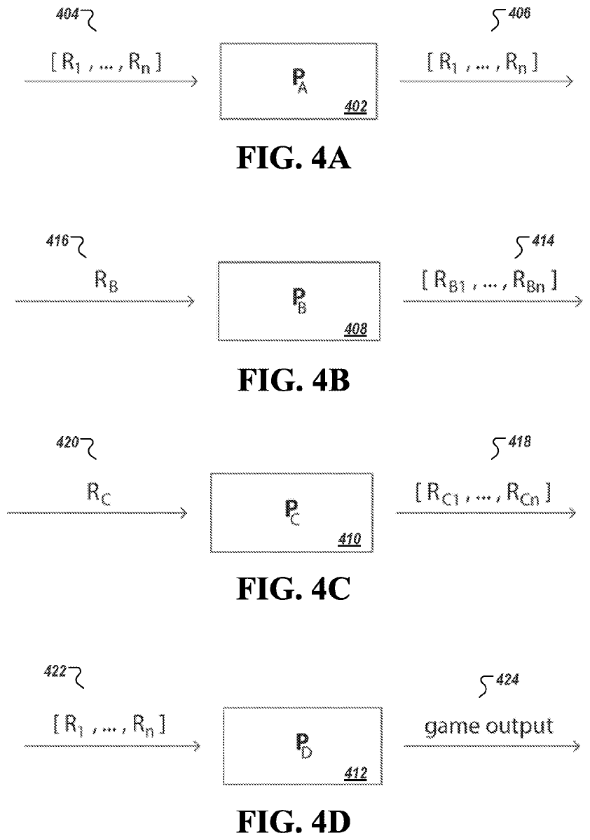

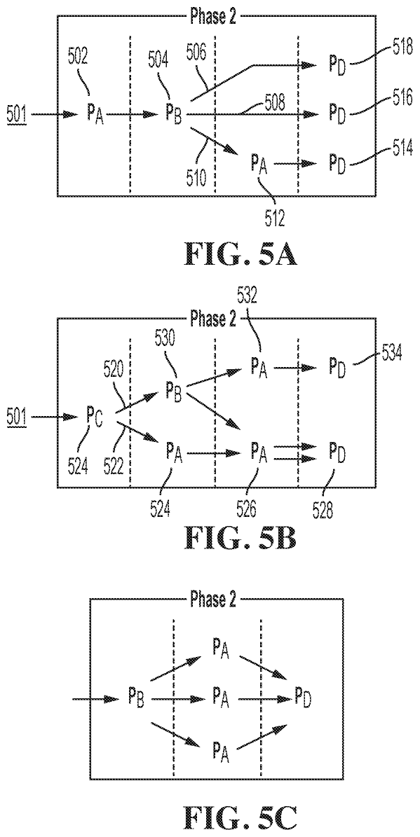

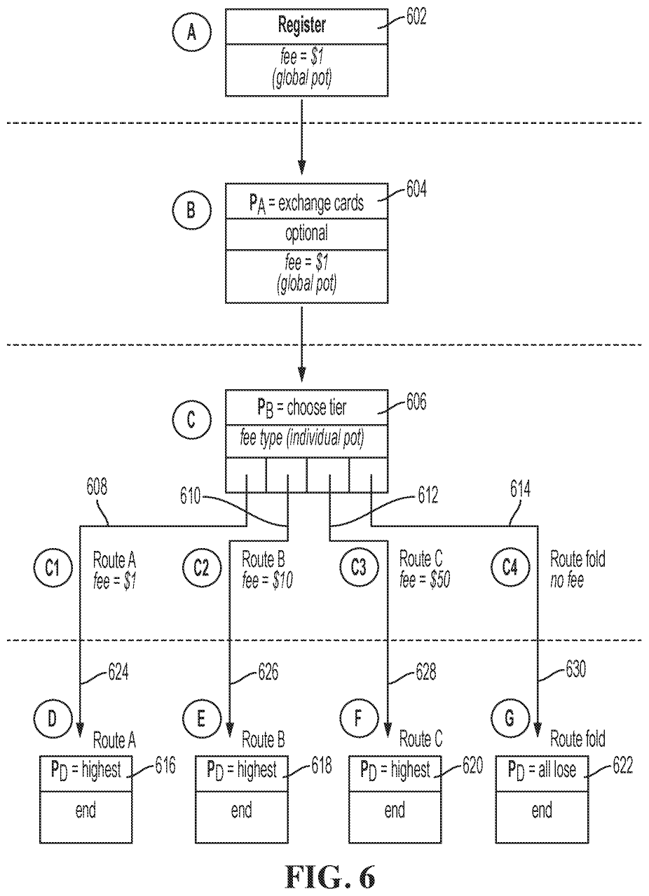

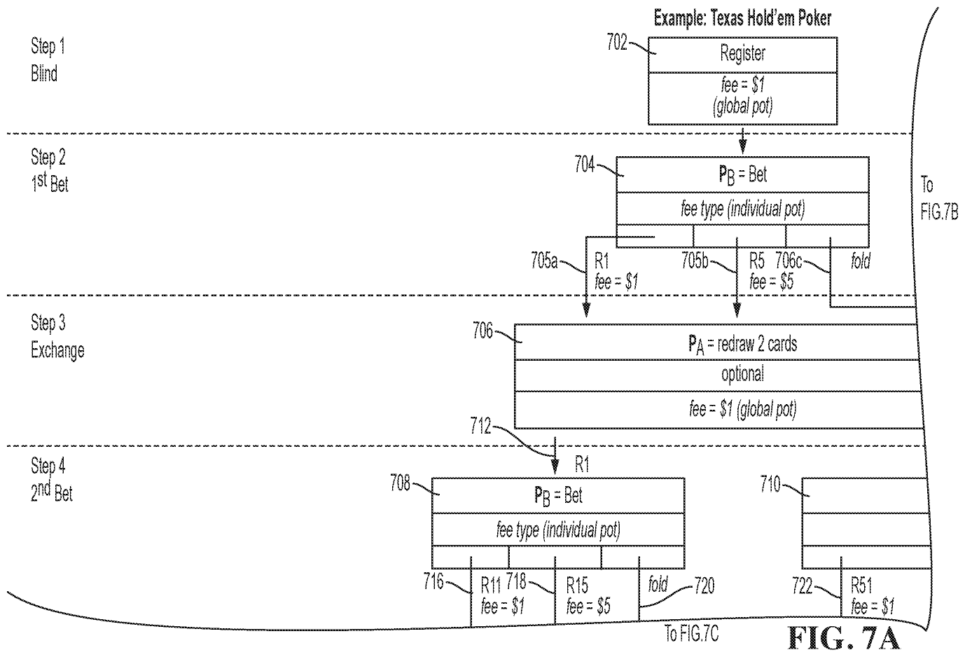

FIGS. 4A, 4B, 4C, and 4D depict processing modules of multiplayer wagering game system, in accordance with an example embodiment of the present disclosure. One or more processing modules are arranged in a structure for the players to traverse through the game. The routing of the player to a respective group may be based on the actions of the players or the player's hand. In some embodiments, multiple processing modules are employed in combinations to form the flow of the multiplayer wagering game. Certain modules alter the game piece of the players, while certain modules receive one or more inputs from the player to route the player through a given game path, while further certain modules determine the payout and/or outcome for the player. A game developer can combine the various modules to create a multiplayer wagering game. These multiplayer wagering games may be based on traditional player-versus-players games or entirely new games that are derived in parts from traditional player-versus-players games.

FIG. 4A depicts a type of process block 402 for altering tokens. This type of block is also referred to herein as “Process A”. The token altering process block 402 allows players to modify the player's hands with substituted tokens to potentially improve the combination of assigned tokens formed within the player's hand. In some embodiments, the token altering process block 402 allows players to exchange all, or part of, the assigned player's tokens. The process block 402 may require a fee, wager, or the like, from the player to allow for the exchange. In some implementations, the system assigns a set of game tokens to the players and then prompts the player with a selectable option to exchange, some, all, or none of the tokens. An exemplary implementation of the altering process block 402 allows the player to exchange, for example, one, two, or three of three assigned cards of each player of the multiplayer game (e.g., in “Texas hold 'em poker” based multiplayer wager game). In another exemplary implementation, the altering process block 402 allows the player to exchange, for example, one, two, three, four, five of five assigned tokens each player of the multiplayer game (e.g., in “five card draw poker”). The player may elect to not exchange any tokens in the player's current hand.

To exchange a card, the altering process block 402 removes an assigned token from the player's hand and assigns, via a pseudorandom or random process, a new token from the personal collection (e.g., personal deck) specific to that player. In some implementations, the altering process block 402 removes a discarded token from a list of potential selectable tokens for a given player. In other implementations, the altering process block 402 maintains a list of discarded tokens and compares any newly selected token to such list. In case of a match, the altering process block 402 reassigns another token.

In other embodiments, the token altering process block 402 allows players to add tokens to the player's hand. In an exemplary implementation, the altering process block 402 allows the player to add cards to the player's hand (e.g., in a Blackjack type game). In another exemplary implementation, the altering process block 402 adds community tokens (e.g., cards) from the community deck to all the players.

In other embodiments, the token altering process block 402 allows players to remove tokens from the player's hand. For certain games, such a derivative game, the system may allow the player to replay a new hand (e.g., a new set of game tokens).

The token altering process block 402 comprises an input from one or more routes 404 (shown as R₁, . . . , Rₙ) and an output to one or more routes 406 (shown as R₁ . . . Rₙ). In some embodiments, the number of outputs 406 corresponds to the number of inputs 404.

In some embodiments, the token altering process block 402 requires a fee for the player to continue or to modify the tokens in the player's hand. In some embodiments, the fee is based on the number of tokens in the player's hand that the player elects to exchange or modify. In other embodiments, the fee is fixed.

FIG. 4B depicts a type of process block 408 (e.g., “decisional rerouting”) for receiving an input from the player for routing the player to a game stage within the multiplayer wagering game. This type of process block is also referred to herein as “Process B”. The decision process block 408 requires a player to elect one of a multiple of provided selectable options. In some embodiments, the provided options is an election of provided set of game rules. In some embodiments, the provided option is based on an additional wager, a fee, and the like, that the player can place to the multiplayer wagering game. The process blocks 408 has an output to one or more routes 414 (shown as routes R_{B1}, . . . , R_{Bn}) (depending on the election made) and an input from a single route 416 (shown as route R_{B}).

The additional wager and/or election is used, by the present system, to segment the players into subgroups in which the different subgroups provide a different payout amount or a condition for winning. For example, the provided option may allow the player to place a wager of “$1”, “$10”, “$50”, or none, and the subgroups associated with such wager may allow the player to win, respectively, for example, up to 10%, 20%, and 70% of the total wager pot. Consistent with this, an election of a selectable wager of, e.g., “$1”, “$10”, “$50”, or none, may result in the player being placed a respective subgroup, e.g., a first subgroup, a second subgroup, a third subgroup, a fourth subgroup. An example of the payout rules within each subgroup, e.g., first, second, third, and fourth subgroup, is provided in Table 1. It should be appreciated that the payout amount and percentages are merely illustrative and that other payout amounts, conditions, and percentages may be employed.

TABLE 1

| Subgroup | Rule |
|---|---|
| Subgroup A | A player with the best hand receives a reward |
| | payout of, e.g., 10% of the global pot and |
| | all the individual pots in the subgroup. |
| Subgroup B | A player with the best hand receives a reward |
| | payout of, e.g., 20% of the global pot and |
| | all the individual pots in the subgroup. |
| Subgroup C | A player with the best hand receives a reward |
| | payout of. e.g. 70% of the global pot and |
| | all the individual pots in the subgroup. |
| Subgroup D | A player is in subgroup receives, e.g., no |
| | payout. |

In some embodiments, the provided option is based on a set of game conditions to determine the payout for a given subgroup. These conditions may be based on a calculation performed by the system. For example, the system may provide a target number, e.g., “21” synonymous in Blackjack. The payout condition may be the highest hand in the group that is closest to, but not exceed, “21.” Another example is a calculation based on a mean of the token values in a player's hand, the mean of community tokens, or the mean of all the token values of all the players in a given game.

FIG. 4C depicts a type of process block 410 (e.g., “conditional rerouting”) for routing the player to a game stage within the multiplayer wagering game. The process block 410 allows game developers to separate players based on conditions. The decision process block 410 does not require a player to make any decision or take any action. The process block 410 includes an input from a single route 420 (shown as route Rₑ), but has an output to one or more routes 418 (shown as routes R_{c1}, . . . , R_{cn}). The number of routes may be specified as a configurable parameter in the block to allow editing by the game developer. Each output has an associated game condition to allow the routing to occur. There can be as many output routes as needed to comply with the game rules. In some embodiments, the process block can provide a payout, which can be specified as a parameter in the process block. The process block 410 has an output to a plurality of outputs and a single input for each player.

FIG. 4D depicts a type of process block 412 (e.g., “computing outcome”) for calculating the outcome and the payout rate of the multiplayer wagering game. The process block 412 has an input from one or more routes 422 (shown as routes R₁ to Rₙ). The output of the block 412 is the outcome of the game (424) for a given route. In some implementations, all players must take the action in this process block. The process block 412 provides a trigger for a payout, which corresponds to the stated game rules. In some implementations, the process block 412 provides the calculations for the outcome.

As stated above, a game developer can selectably combine the various modules to create a multiplayer wagering game. To assist the game developer, the process blocks may be arranged according to certain rules. Below are example rules for combining the game modules.
1) There must be at least one altering token process block (P_{A}). This would allow players to take actions with their token(s).
2) There must be at least one decision routing or conditional routing process block (P_{B} or P_{C}). This would allow the players to take different routes to create a more complex gaming experience.
3) There must be at least one game computing outcome process block (P_{D}) to calculate the game outcome.
4) At least one of the computing outcome process blocks (P_{D}) must give out a reward.
5) All routes entering the process block must come from the game registration block.
6) There must be at least one route from the game registration block.
7) All routes must leads to, and end with, the computing outcome process block (P_{D}).
8) No route may reverse back to a previous process.

In some implementations, the various processing modules are implemented as code modules, instruction, application programming interfaces (APIs), and the like, e.g., provided in a library, that can be combined to create a new game. In other implementations, the processing modules are presented as graphical code elements that can be linked, in a development workspace, to create a new game.

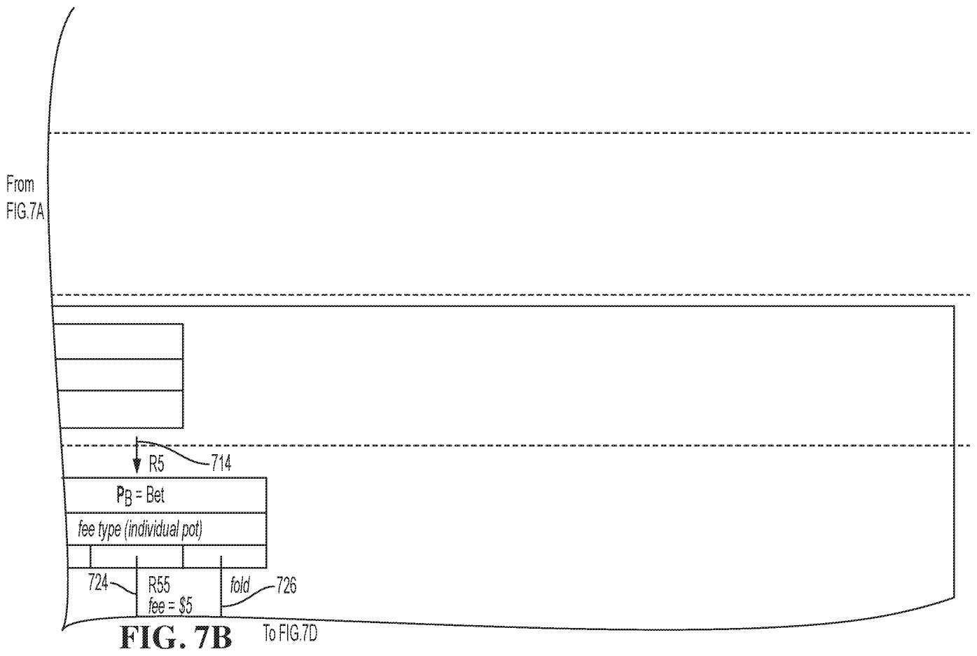

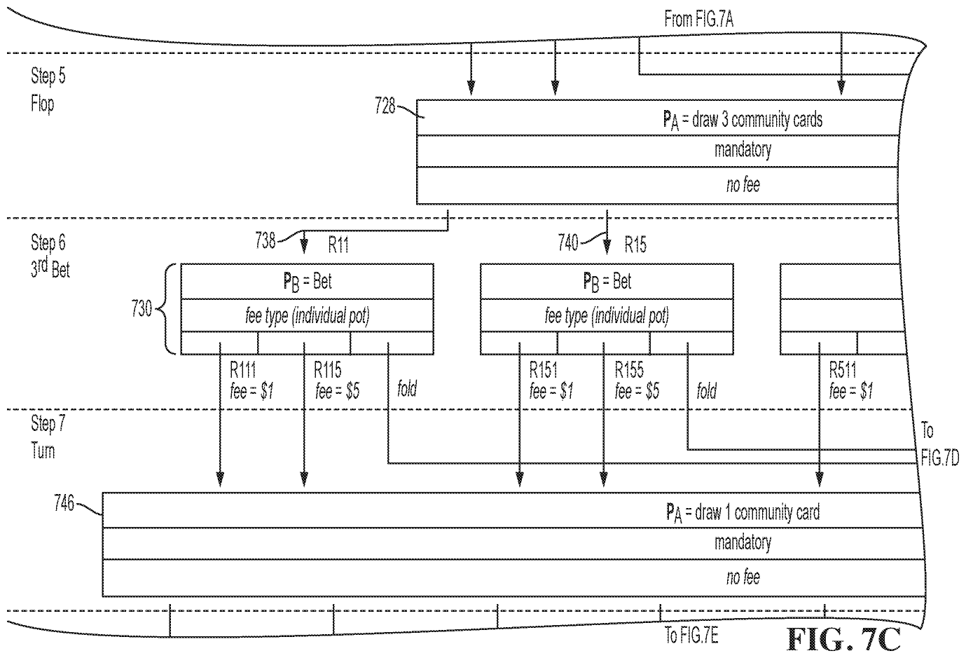

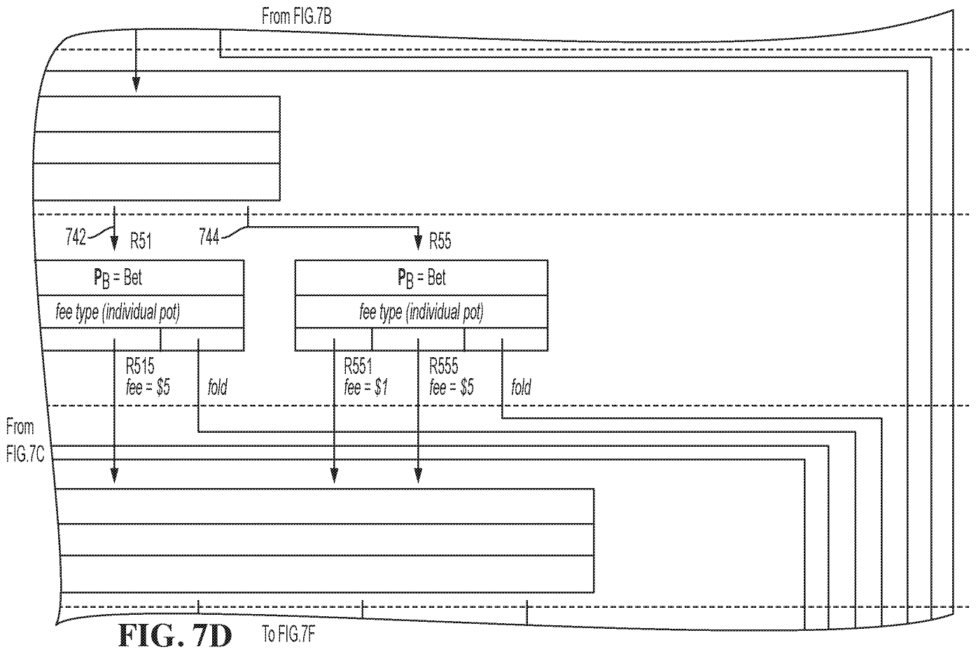

FIGS. 5A, 5B, and 5C depict an exemplary combination of the grouping of the various process module blocks to create a multiplayer wagering game. As shown in FIG. 5A, after completing registration 501 and joining a game, a player receives a set of game tokens and is given an option to exchange one or more of the receiving tokens. As a non-limiting example, the combinations of process module blocks are labeled as “Phase 2.” The exchange is performed, for example, but not limited, a token process block (P_{A}) 502. As a non-limiting example, the game, up to this point, can have similar game play as “draw poker.”

After the token exchange, the system prompts the player with one or multiple selectable options in routing block (P_{B}) 504. These selectable options may be based on a) a wager or fee amount, b) a set of game play, or c) a condition for winning and/or payout. Here, the example shows the player can be routed to one of three possible subgroups 514, 516, 518.

As a non-limiting example, in the first route 510 associated with subgroup 514, the player has the option of exchanging the player's token again. This is performed, in this example, in token process block (P_{A}) 512 prior to the player ranking being determined in subgroup 1 in the outcome process block (P_{D}) 514. The player's ranking is determined among the other players whom have made the same decision in routing block (P_{B}) 504 in selecting subgroup 1.

In the second route 508, the system determines the player's rank among the other players whom have made the same decision in routing block (P_{B}) 504. The determination, in this example, is performed in outcome process block (P_{D}) 516.

In the third route 506, the system determines the player's rank among the other players whom have made the same decision in routing block (P_{B}) 504 in selecting subgroup 3. The determination, in this example, is performed in outcome process block (P_{D}) 518.

In some embodiments, the segmentation of the players is based on a wager amount, or a player's election of the payout rule. In addition, the condition for payout between subgroup 2 and subgroup 3 may be specified to be the same or different.

FIG. 5B illustrates that players can be combined during the game play based on the player's action. After the initial registration 501 and joining a game, each player receives a set of game tokens and is segmented into one of two routes 520, 522. The segmentation is performed via conditional routing process block (P_{c}) 524. As a non-limiting example, this can be based on player's hand or the sequence of the player in joining the game. The segmentation can be performed in a manner that the player is not aware of the operation. That is, the system may not communicate or present such state information to the player during game play.

As a non-limiting example, in the first route 522, the system presents the player with two opportunities to exchange the player's token before the outcome is determined. As shown, this is performed via token process blocks 524, 526. The ranking of the player is then determined in outcome process block (P_{D}) 528.

As a non-limiting example, in the second route 520, the player is given an option to elect subgroup 1 or subgroup 2 via routing block (P_{B}) 530. This routing block 530 allows players to be combined during the game play, e.g., based on the player's action. If the player in routing block 530 elects subgroup 1, the player is combined with players in route 522. The two groups of players (from routing block 530 and route 522) are then given the option to exchange tokens (in token process blocks 526) prior to being ranked in the outcome process block (P_{D}) 528. If the player in the routing block 530 elects subgroup 2, the player is given the option to exchange tokens in token process blocks 532 prior to being ranked in the outcome process block (P_{D}) 534.

FIG. 5C illustrates that the route going into outcome process block (P_{D}) may come from different supgroups in the prior stage.

### Community Means and Personal Means

To allow for traditional card games that have shared game tokens, such as “Texas hold 'em poker”, and the like, the multiplayer wagering game maintains, in certain embodiments, two distinct card decks: a community card deck and a personal card deck.

Personal card decks are maintained for each player. That is, for a given game, there are N number of personal card decks for N number of players.

Community card decks are maintained for each game. The community card deck is drawn from when a shared token, card, or the like, is provided in the game rules. When a shared token is drawn from the community deck, the multiplayer wagering system substitutes the drawn card with a substitute card or token from the personal deck of the player. This prevent duplicate cards from occurring in the player's hand, which beneficially allows existing ranking rules (e.g., Poker rank rules, e.g., “straight flush”, “four-of-a-kind”, “full house”, “three-of-a-kind”, “straight”, “flush”, “pairs’, etc.) to be used. Without wishing to be bound to a particular theory, the usage of existing known rules promotes the appeal of the present multiplayer wagering game in keeping the gameplay similar to existing traditional game.

As described herein, the community card deck is an aspect of a community mean. That is, a rule or game play that is universal for every players in the game. The personal card deck is an aspect of a personal mean. That is, the card deck is employed in rules or gameplay that are specific for each individual player. The community means and personal means are described in further detail in the provided Examples. Depending on the game rules, the players may not receive the same number of community cards, e.g., if the player folds or surrenders during the game play, or are grouped into certain groups that provide different numbers of community cards as part of the game play.

### Types of Pots

The present technology allows for more than one distinct type of pots. As a non-limited example, the multiplayer wagering game system may maintain a global pot and an individual pot. Game developers can specify the payout of a given outcome process block (P_{D}) (as well as conditional routing process block (P_{C})) based on the types of pot specific to, or associated with, a given group. A global pot, and the like, refers to a pot that is universal for every player in the game. That is, the global pot can receive wagers, antes, and the like, from any player at the beginning or during game play. In some implementations, the multiplayer wagering game system maintains a single global pot for a given multiplayer wagering game. In other implementations, the wagering game system maintains multiple global pots that are, for example, selectable, in terms of contribution, by the player.

In contrast, each individual pot, and the like, is associated with a given player during the game play, for example, when the players are routing through the game. A given individual pot is maintained for each player, in certain game embodiments, until the end of the game. In some implementations, the system maintains the individual pots of the players until the game state reaches an outcome process block. Once the game state reaches an outcome process block, the process block combines the individual pots of each player in the group. The system then uses the combined sum to determine one or more payouts for the group. In certain process blocks, the individual pots are combined and transferred to the global pot. In certain embodiments, the system uses the individual pots to determine the routing of the players through the multiplayer game.

Each payment associated with a fee, wager, and the like is applied to one of a global pot or the individual pot. The system preferably indicates, to the players, the pot to which the player's payment is applied, or to be applied, with a given selectable option. In some embodiments, the system presents, via a user interface associated with a given player computing device, the global pot and player's individual pot for a given game. In some embodiments, the system prompts the player with the information, via the user interface of the player, when a payment option is presented. In certain embodiments, the system presents the global and/or cumulative individual pots for a given selectable option along with the selectable options prior to the player's selection.

### EXEMPLIFICATION

The term “steps”, as used herein, is a non-limiting label and can be used interchangeably with term process modules and/or stages, and the likes.

### Example 1: “Classic Poker Game”

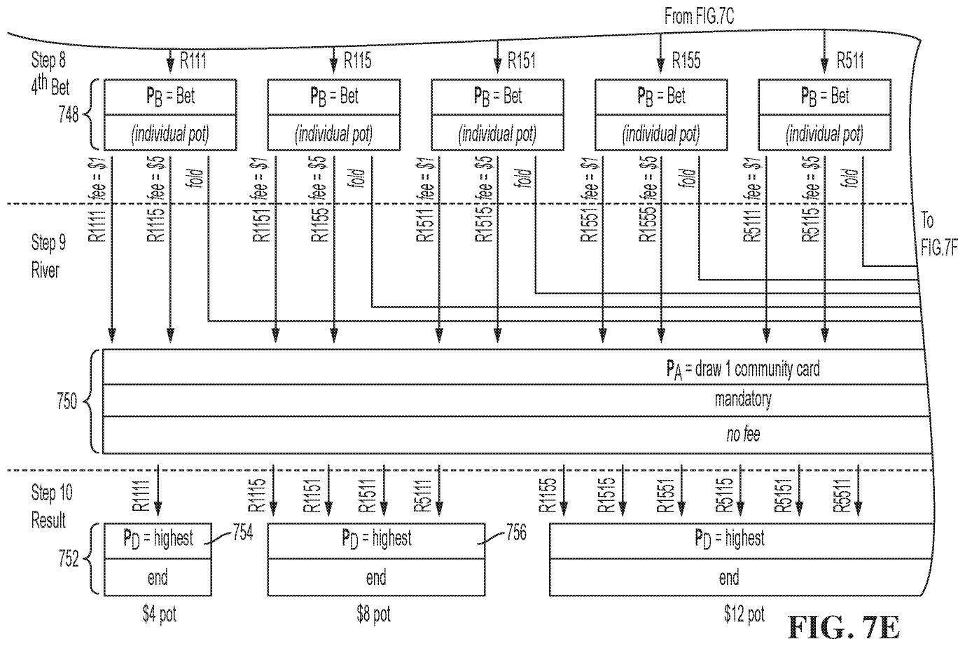

FIG. 6 depicts an exemplary multiplayer wagering game based on a “classic poker game”, in accordance with an example embodiment of the present disclosure. Personal Mean: The system maintains a playing card deck for each player.
Step 1: Each player pays a blind fee (e.g., $1), which is applied to a global pot, to join a game (step 602). Once the registration period has lapsed, each player receives cards (e.g., 5 cards) from the player's personal deck.
Step 2: (Process A, Optional Action) The system prompts each player to exchange the player's card (step 604) (e.g., up to 3 cards). To perform the exchange, a player provides a payment, a wager, or the like, (e.g., $1), which is applied to the global pot.
Step 3: (Process B) The system prompts each player with a set of selection options related to a wager amount (step 606).
   Examples of Selectable Options
   1. Route “A” (608): A first fee (e.g., $1) is required (individual pot);
   2. Route “B” (610): A second fee (e.g., $10) is required (individual pot);
   3. Route “C” (612): A third fee (e.g., $50) is required (individual pot); and
   4. Route “Fold” (614): no fee is required (Surrender).
Step 4: (Process D) The system calculates a payout and/or winner outcome for each route/group (blocks 616, 618, 620, 622).
   Examples of Processing for Each Respective Group
   Route “A” (624): The outcome process block 616 ranks each player in this group against other players in the group. The player with, e.g., the highest rank hand (e.g., highest poker hand) wins and receives a reward payout. The payout is calculated as, e.g., 10% of the global pot plus all the individual pots of the other players in this group. In the event of a tie, the payout is distributed in equal amounts to all the winners.
   Route “B” (626): The outcome process block 618 ranks each player in this group against other players in the group. The player with, e.g., the highest rank hand (e.g., highest poker hand) wins and receives a reward payout. The payout is calculated as, e.g., 20% of the global pot plus all the individual pots of the other players in the group. In the event of a tie, the payout is distributed in equal amounts to all the winners.
   Route “C” (628): The outcome process block 620 ranks each player in this group against other players in the group. The player with, e.g., the highest rank hand (e.g., highest poker hand) wins and receives a reward payout. The payout is calculated as, e.g., 70% of the global pot plus all the individual pots of the other players in the group in this process block. In the event of a tie, the payout is distributed in equal amounts to all the winners.
   Route “Fold” (630): Players in this group receive no payout. The outcome process block 622 transfers individual pots associated with each player in the group to the global pot. The transfer may occur i) prior to the payout in the other process blocks 616, 618, 620 (i.e., the individual pots are applied to winners of the current game) or ii) subsequent to the payout (i.e., they are applied to the next game).

### Example 2: “Texas Hold 'Em Poker Game”

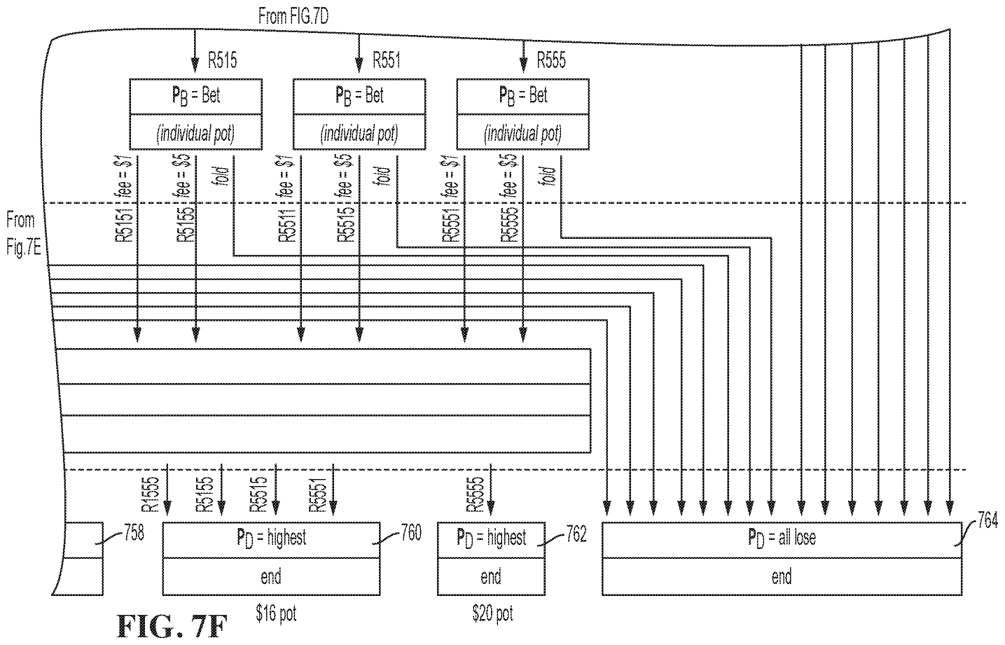

FIG. 7 depicts an exemplary multiplayer wagering game based on “Texas hold 'em poker,” in accordance with an example embodiment of the present disclosure. Community Mean: The system maintains a playing card deck common to all of the players. Personal Mean: The system maintains a playing card deck for each player.
Step 1: Each player pays a blind fee (e.g., $1), which is applied to a global pot, to join a multiplayer game (step 702). Once the registration period has lapsed, each player receives cards (e.g., 2 cards) from the player's personal deck.
   Step 2: (Process B) The system presents the players with a first set of selectable options (e.g., selectable routes or states within the game) via a graphical user interface rendered on a computing device associated with a given user (step 704).
   Examples of First Selectable Options
   Route “1” (705a): A first-value fee (e.g., $1) to be paid to the player's individual pot;
   Route “5” (705b): A second-value fee (e.g., $5) to be paid to the player's individual pot; and
   Route “Fold” (705c): No fee to be paid (Surrender).
Step 3: (Process A, Optional Action) The system prompts the player with a selectable option to exchange cards (e.g., up to 2 cards) in the player's hand (step 706). The system draws the new cards from their personal deck. To make the exchange, the system requires the player to pay a fee (e.g., $1), place a wager, and the like.
Step 4: (Process B) The system prompts each player with a second set of selectable options related to a wager amount. The selectable options presented to the players are, e.g., dependent on the previously selection of the user which corresponds to a game state or position (708, 710) within the game.
   Examples of Second Selectable Options
   A. From Route “1” (712)—the player can make the options of:
      1. Route “11” (716): A first-value fee (e.g., $1) to be paid to the player's individual pot;
      2. Route “15” (718): A second-value fee (e.g., $5) to be paid to the player's individual pot; and
      3. Route “Fold” (720): No fee to be paid (Surrender).
   B. From Route 5 (714)—the player can make the options of:
      1. Route “51” (722): A first-value fee (e.g., $1) to be paid to the player's individual pot);
      2. Route “55” (724): A second-value fee (e.g., $5) to be paid to the player's individual pot; and
      3. Route “Fold” (726): No fee to be paid (Surrender).
Step 5: (Process A) The system assigns community cards (e.g., 3 community cards, e.g., for a “best 5 out of 7 poker hand”) that is applied to all the players (step 728). These community cards are drawn from the community deck. The system determines for each player if any of the player cards match that of any of the assigned community cards. For each match, the system exchanges the matched community card with a new card drawn from the player's personal deck. In some embodiments, the system causes the graphical presentation of an icon or message to indicate to the player that at least one of the cards in their hand are discarded and a replacement card has been drawn. In some embodiments, the player is notified of the replacement cards. In other embodiments, the system does not present any duplicate cards to the players and automatically performs the substitution, and the final substituted cards are shown to the player such that the player is not aware of the substitution.
Step 6: (Process B) The system prompts each player with a third set of selectable options related to a wager amount. The selectable options are, e.g., dependent on the state of the player within the game (730).
   Examples of Third Selectable Options
   A. From Route “11” (738)—the player can select an option of:
      1. Route “111”: A first-value fee (e.g., $1) to be paid to the player's individual pot;
      2. Route “115”: A second-value fee (e.g., $5) to be paid to the player's individual pot; and
      3. Route “Fold”: No fee to be paid (Surrender).
   B. From Route “15” (740)—the player can select an option of:
      1. Route “151”: A first-value fee (e.g., $1) to be paid to the player's individual pot;
      2. Route “155”: A second-value fee (e.g., $5) to be paid to the player's individual pot; and
      3. Route “Fold”: No fee to be paid (Surrender).
   C. From Route “51” (742)—the player can select an option of:
      1. Route “511”: A first-value fee (e.g., $1) to be paid to the player's individual pot;
      2. Route “515”: A second-value fee (e.g., $5) to be paid to the player's individual pot; and
      3. Route “Fold”: No fee to be paid (Surrender).
   D. From Route “55” (744)—the player can select an option of:
      1. Route “551”: A first-value fee (e.g., $1) to be paid to the player's individual pot;
      2. Route “555”: A second-value fee (e.g., $5) to be paid to the player's individual pot; and
      3. Route “Fold”: No fee to be paid (Surrender).
Step 7: (Process A) The system presents one or more additional community cards (e.g., a 4^{th} community card, e.g., for a “best 5 out of 7 poker hand”) that is applied, e.g., to all the players (step 746). These community cards are drawn from a community deck. The system determines for each player if any of the player cards match that of any of the assigned community cards. For each match, the system exchanges the matched community card of the player with a new card drawn from the player's personal deck. The system may or may not present any duplicate cards to the players and automatically performs the substitution. The final substituted cards are shown to the player.
Step 8: (Process B) The system prompts each player with a fourth set of selectable options related to a wager amount. The selectable options are, e.g., dependent on the state of the player within the game (748).
   Examples of Fourth Selectable Options
   A. From Route “111”—the player can select an option of:
      1. Route “1111”: A first-value fee (e.g., $1) to be paid to the player's individual pot;
      2. Route “1115”: A second-value fee (e.g., $5) to be paid to the player's individual pot; and
      3. Route “Fold”: No fee to be paid (Surrender).
   B. From Route “115”—the player can select an option of:
      1. Route “1151”: A first-value fee (e.g., $1) to be paid to the player's individual pot;
      2. Route “1155”: A second-value fee (e.g., $5) to be paid to the player's individual pot; and
      3. Route “Fold”: No fee to be paid (Surrender).
   C. From Route “151”—the player can select an option of:
      1. Route “1511”: A first-value fee (e.g., $1) to be paid to the player's individual pot;
      2. Route “1515”: A second-value fee (e.g., $5) to be paid to the player's individual pot; and
      3. Route “Fold”: No fee to be paid (Surrender).
   D. From Route “155”—the player can select an option of:
      1. Route “1551”: A first-value fee (e.g., $1) to be paid to the player's individual pot;
      2. Route “1555”: A second-value fee (e.g., $5) to be paid to the player's individual pot; and
      3. Route “Fold”: No fee to be paid (Surrender).
   E. From Route “511”—the player can select an option of:
      1. Route “5111”: A first-value fee (e.g., $1) to be paid to the player's individual pot;
      2. Route “5115”: A second-value fee (e.g., $5) to be paid to the player's individual pot; and
      3. Route “Fold”: No fee to be paid (Surrender).
   F. From Route “515”—the player can select an option of:
      1. Route “5151”: A first-value fee (e.g., $1) to be paid to the player's individual pot;
      2. Route “5155”: A second-value fee (e.g., $5) to be paid to the player's individual pot; and
      3. Route “Fold”: No fee to be paid (Surrender).
   G. From Route “551”—the player can select an option of:
      1. Route “5511”: A first-value fee (e.g., $1) to be paid to the player's individual pot;
      2. Route “5515”: A second-value fee (e.g., $5) to be paid to the player's individual pot; and
      3. Route “Fold”: No fee to be paid (Surrender).
   H. From Route “555”—the player can select an option of:
      1. Route “5551”: A first-value fee (e.g., $1) to be paid to the player's individual pot;
      2. Route “5555”: A second-value fee (e.g., $5) to be paid to the player's individual pot; and
      3. Route “Fold”: No fee to be paid (Surrender).
Step 9: (Process A) The system presents one or more additional community cards (e.g., a 5^{th} community card, e.g., for a “best 5 out of 7 poker hand”) that is applied, e.g., to all the players (step 750). These community cards are drawn from a community deck. The system determines for each player if any of the player cards match that of any of the assigned community cards. For each match, the system exchanges the matched community card with a new card drawn from the player's personal deck. The system may or may not present any duplicate cards to the players and performs the substitution. The final substituted cards are shown to the player.
Step 10: (Process D) The system calculates a payout and/or winner outcome for each route/group (752).
   Examples of Processing for Each Respective Group
   Route “1111” (754):
   (e.g., $4 pot route) The process block 754 ranks each player in this group against other players in the group. The player with the highest rank hand (e.g., highest poker hand) wins and receives a reward payout. The payout is calculated as, e.g., 5% of the global pot plus all the individual pots of the other players in the group in this process block. In the event of a tie, the payout is distributed in equal amounts to all the winners.
   Route “1115”, “1151”, “1511”, “5111” (756):
      (e.g., $8 pot route) The process block 756 ranks each player in this group against other players in the group. The player with the highest rank hand (e.g., highest poker hand) wins and receives a reward payout. The payout is calculated as, e.g., 10% of the global pot plus all the individual pots of the other players in the group in this process block. In the event of a tie, the payout is distributed in equal amounts to all the winners.
   Route “1155”, “1515”, “5115”, “1551”, “5151”, “5511” (758):
      (e.g., $12 pot route) The process block 758 ranks each player in this group against other players in the group. The player with the highest rank hand (e.g., highest poker hand) wins and receives a reward payout. The payout is calculated as, e.g., 15% of the global pot plus all the individual pots of the other players in the group in this process block. In the event of a tie, the payout is distributed in equal amounts to all the winners.
   Route “1555”, “5155”, “5515”, “5551” (760):
      (e.g., $16 pot route) The process block 760 ranks each player in this group against other players in the group. The player with the highest rank hand (e.g., highest poker hand) wins and receives a reward payout. The payout is calculated as, e.g., 20% of the global pot plus all the individual pots of the other players in the group in this process block. In the event of a tie, the payout is distributed in equal amounts to all the winners.
      Route “5555” (762):

(e.g., $20 pot route) The process block 762 ranks each player in this group against other players in the group. The player with the highest rank hand (e.g., highest poker hand) wins and receives a reward payout. The payout is calculated as, e.g., 50% of the global pot plus all the individual pots of the other players in the group in this process block. In the event of a tie, the payout is distributed in equal amounts to all the winners.
Route “Fold” (764): Players in this group receive no payout. The process block 764 transfers individual pots associated with each player in the group to the global pot.

As shown, this Example demonstrates that players may be joined and/or grouped at later stages in the game. As a non-limiting example, the grouping is based on cumulative decisions made and/or wager amounts placed by the players.

### Example 3: “Derivative Poker Game”

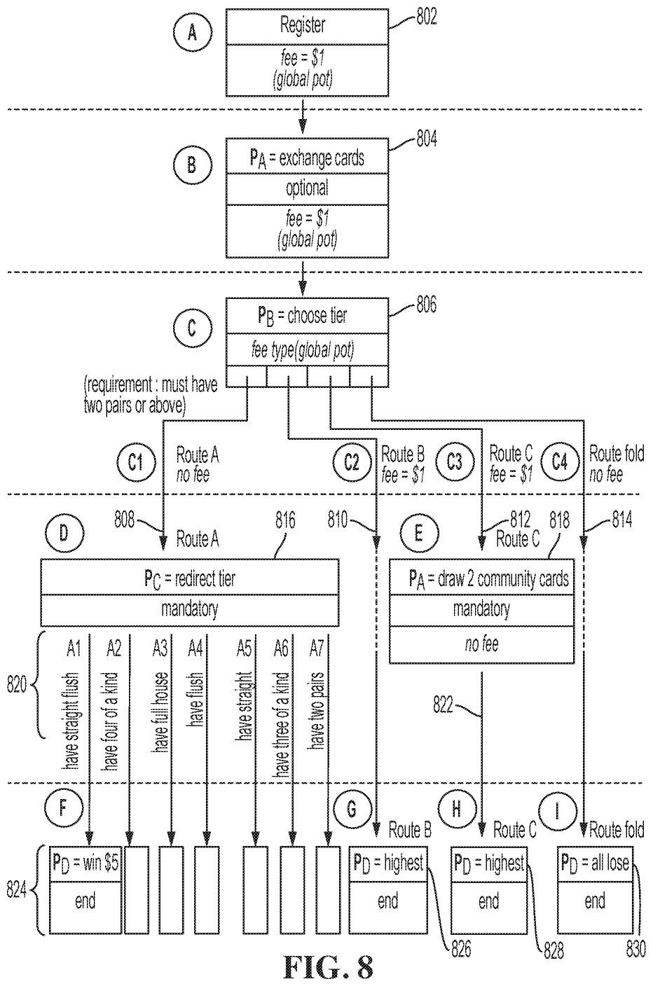

FIG. 8 depicts an exemplary multiplayer wagering game based on Derivative Poker, in accordance with an example embodiment of the present disclosure.

Community Mean: The system maintains a playing card deck common to all of the players.
Personal Mean: The system maintains a playing card deck for each player.
Step 1: Each player pays a blind fee (e.g., $1), which is applied to a global pot, to join a multiplayer game (step 802). Once the registration period has lapsed, each player receives cards (e.g., 5 cards) from the player's personal deck.
Step 2: (Process A, Optional Action) The system prompts the player with a selectable option to exchange cards (e.g., up to 3 cards) in the player's hand (step 804). The system draws the new cards from their personal deck. The system prompts the player to pay a fee (e.g., $1), which is applied to the global pot, to make the card exchange.
Step 3: (Process B) The system presents the players with a set of selectable options (e.g., selectable routes or states within the game) via a graphical user interface rendered on a computing device associated with a given user (step 806).
   Example of the Selectable Options
   1. Route “A” (808): No fee to be paid, but a player must have 2 pairs or higher to select this option;
   2. Route “B” (810): A first-value fee (e.g., $1) to be paid to the global pot;
   3. Route “C” (812): A second-value fee (e.g., $1 to be paid to the global pot; and
   4. Route “Fold” (814): No fee to be paid (Surrender).
Step 4: Each different route may have a different process, as performed by the system.
   Route “A” (808): (Process C) Players directed to this route are further directed to sub-route 820 based on the contents and/or ranks of the player's hand (step 816).
   Example of Sub Routes
      Route “A1”: Players with a “straight flush”;
      Route “A2”: Players with a “four-of-a-kind”;
      Route “A3”: Players with a “full house”;
      Route “A4”: Players with a “flush”;
      Route “A5”: Players with a “straight”;
      Route “A6”: Players with a “three-of-a-kind”; and
      Route “A7”: Players with a “two pairs”.
   Route “B” (810): No action.
   Route “C” (812): (Process A) The system assigns community cards (e.g., 2 community cards, e.g., for a “best 5 out of 7 poker hand”) that is applied to all the players (818). These community cards are drawn from a community deck. The system determines for each player if any of the player cards match that of any of the assigned community cards. For each match, the system exchanges the matched community card with a new card drawn from the player's personal deck. The system may or may not present any duplicate cards to the players and performs the substitution. The final substituted cards are shown to the player.
   Route “D” (814): No action.
Step 5: (Process D) The system calculates a payout and/or winner outcome for each route/group.
   Examples of processing for each respective group
   Route “A1”-“A7” (820): Players directed to each of these blocks 824 receive a reward payout (e.g. 5% of the global pot divided equally among them). In the event that there are no players in this group, the system, e.g., transfers the payout to the global pot of the next game.
   Route “B” (810): Players directed to this group 826 are ranked by the system against other players in the group. The player with the highest poker card hand (e.g., “best 5 out of 7 cards”) wins and receive a reward payout (e.g., 35% of the global pot). In case that the winners are ties, players will split the reward evenly. In the event that there are no players in this group, the system transfers the payout to the global pot of the next game.
   Route “C” (822): Players directed to this group 828 are ranked by the system against other players in the group. The player with the highest poker card hand (e.g., “best 5 out of 7 cards”) wins and receive a reward payout (e.g., 30% of the global pot). In case that the winners are ties, players will split the reward evenly. In the event that there are no players in this group, the system transfers the payout to the global pot of the next game.
   Route “Fold” (814): Players directed to this group receive 830 no reward. All individual pots in this process block are transferred to the global pot.

### Example 4: “Derivative Black Jack Game”

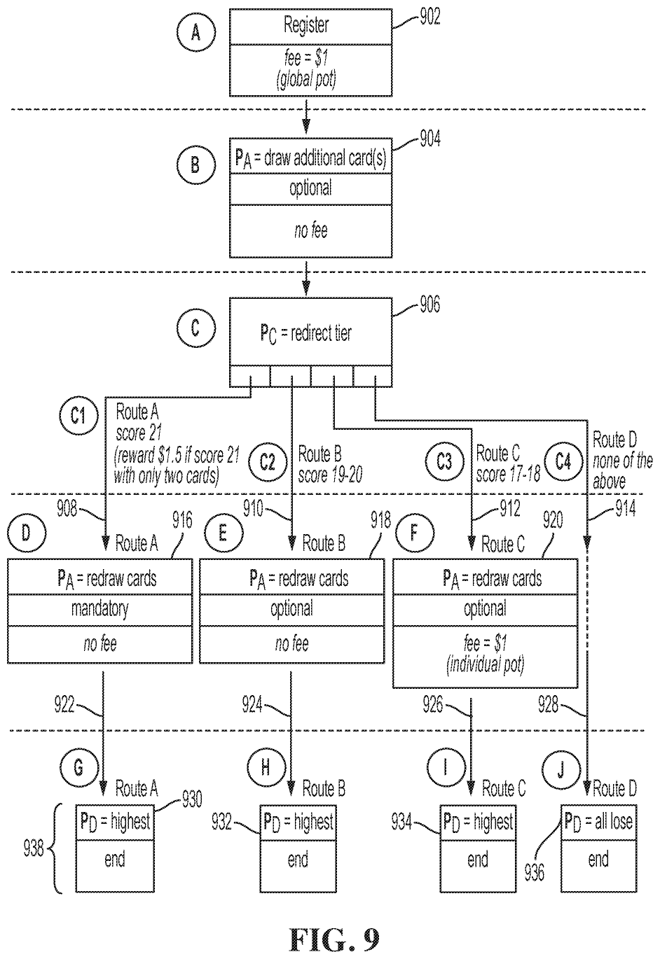

FIG. 9 depicts an exemplary multiplayer wagering game based on Derivative Blackjack, in accordance with an example embodiment of the present disclosure. Community Mean: The system maintains a playing card deck common to all of the players. Personal Mean: The system maintains a playing card deck for each player.
Step 1: Each player pays a blind fee (e.g., $1), which is applied to a global pot, to join a multiplayer game (step 902). Once the registration period has lapsed, each player receives cards (e.g., 2 cards) from the player's personal deck.
Step 2: (Process A, Optional Action) The system prompts each player to exchange the player's cards (step 904). In this example, the system allows the player to exchange, e.g., up to 3 cards (one at a time), which are drawn from the player's personal deck, so long as the sum of the cards do not exceed 21. This process requires no fee.
Step 3: (Process C) The system directs each player to different routes according to the player's hand without input from the user (step 906).
   Example of directed routes
   Route “A” (908): Players with hands that sums to exactly 21;
   Route “B” (910): Players with hands that sum to 19 or 20;
   Route “C” (912): Players with hands that sum to 17 or 18; and
   Route “D” (914): Players who does not satisfy any criteria above.

In addition to being placed in Route “A” 908, each player that has a hand of “21” with only 2 cards receives a payout (e.g., the ante amount multiplied by 1.5, e.g., $1.5 for a $1 ante). The amount of payout is deducted, by the system, e.g., from the global pot. Step 4: (Process A) The system processes each player based on the respective routing of the player.
Example of processing
Route “A” (908): The system allows the player to replay their hand (step 916). For example, the system discards the player's card and assigns new cards (e.g., 2 cards) from the player's personal deck. The system then prompts the player to draw additional cards (e.g., up to 3 additional cards) to obtain the score as close to 21 as possible (but not over 21). This action, e.g., requires no fee.
Route “B” (910): The system allows each player directed to this route to replay their hand (step 918). The system prompts the player whether the player would like to discard the player's hand. If the player choose to this option, the system discards the player's hand and assigns new cards (e.g., 2 cards) from the player's personal deck. The system then prompts the player to draw additional cards (e.g., up to 3 additional cards) to obtain the score as close to 21 as possible (but not over 21). This action, e.g., requires no fee.
Route “C” (912): Each player directed to this route may replay their hand (step 920). The system prompts the player whether the player would like to discard the player's hand. If the player choose to this option, the system discards the player's hand and assigns new cards (e.g., 2 cards) from the player's personal deck. The system then prompts the player to draw additional cards (e.g., up to 3 additional cards) to obtain the score as close to “21” as possible (but not over 21). To replay their hand, the system prompts the players to pay a fee (e.g., $1), which is applied to the player's individual pot.
Route “D” (914): No action.
Step 5: (Process D) The system calculates a payout and/or winner outcome for each route/group (938).
   Examples of processing for each respective group
   Route “A” (922): The process block (930) ranks each player in this group against other players in the group. The player with the highest rank hand (e.g., highest poker hand) wins and receives a reward payout. The player with, e.g., the highest-but-not-over-21 hand receives a reward payout, e.g., 50% of the global pot. In the event of a tie, the payout is distributed in equal amounts to all the winners.
   Route “B” (924): The process block (932) ranks each player in this group against other players in the group. The player with, e.g., the highest rank hand wins (e.g., highest poker hand) and receives a reward payout. The player with the highest-but-not-over-21 hand receives a reward payout, e.g., 30% of the global pot. In the event of a tie, the payout is distributed in equal amounts to all the winners.
   Route “C” (926): The process block (934) ranks each player in this group against other players in the group. The player with, e.g., the highest rank hand (e.g., highest poker hand) wins and receives a reward payout. The player with the highest-but-not-over-21 hand receives a reward payout, e.g., 20% of the global pot. In the event of a tie, the payout is distributed in equal amounts to all the winners.
   Route “D” (928): Players in this group receive no payout.

### Example 5: Dice Game

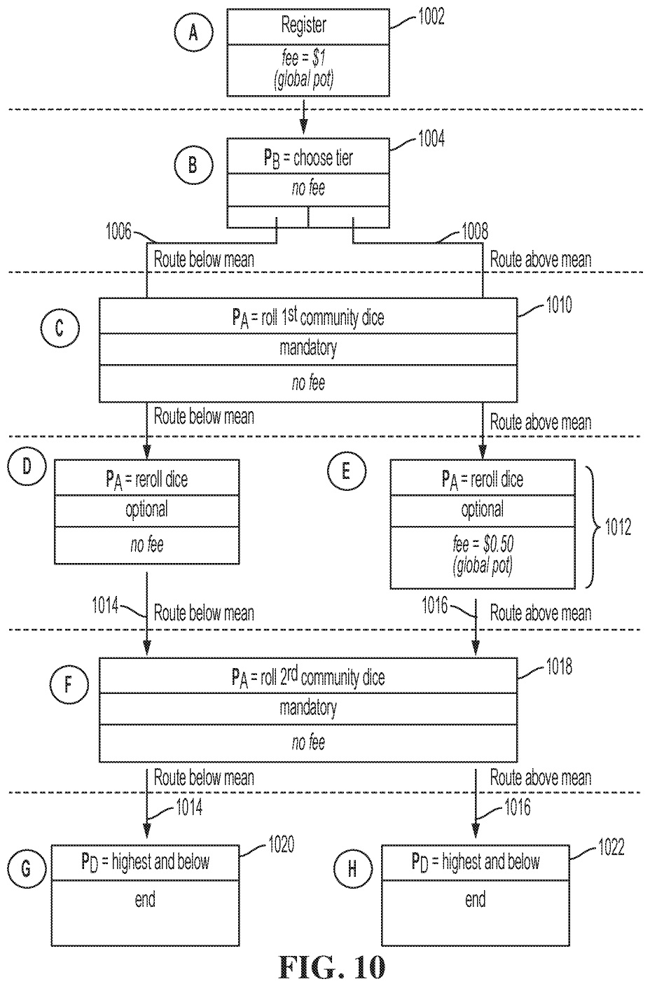

FIG. 10 depicts an exemplary multiplayer wagering game based on rolling-dice, in accordance with an example embodiment of the present disclosure.

Community Mean: e.g., 2 dice
Personal Mean: e.g., 3 dice
Step 1: Each player pays a blind fee (e.g., $1), which is applied to a global pot, to join a multiplayer game (step 1002). Once the registration period has lapsed, each player receives cards (e.g., 3 dice) from the player's personal dice.
Step 2: (Process B) The system calculates a mean (e.g., average) of the dice specific to a player for each of the players. The system then presents each player with a set of selectable options (e.g., selectable routes or states within the game) via a graphical user interface rendered on a computing device associated with a given user (step 1004).
   Example of the options
   1. Route “below mean” (1006): No fee to be paid; and
   2. Route “above mean” (1008): No fee to be paid.
Step 3: (Process A) Both routes (1006, 1008) share the same process. The system assigns a community die to the players (e.g., a 1^{st} community die) (step 1010).
Step 4: (Process A, Optional Action) Both routes (1006, 1008) share the same process. The system prompts each player with an option to reroll one or more of the player's die (e.g., 1 die, 2 dies, or 3 dies) (step 1012). The system also prompts each player with a set of selectable options related to a wager amount.
   Example of selectable options
   Route “below mean” (1014): No fee to be paid; and
   Route “above mean” (1016): A fee (e.g., $0.50) to be paid to the global pot.
Step 5: (Process A) Both routes (1014, 1016) share the same process. The system assigns an additional community die to the players (e.g., a 2nd community die) (step 1018).
Step 6: (Process D) The system calculates a payout and/or winner outcome for each route/group (blocks 1020, 1022). In some embodiments, the “mean” of the game is calculated by the average of the community dies, and the outcome is determined based on a comparison of the community mean to the personal mean (i.e., the average of the personal dies).
   Examples of processing for each respective group
   Route “below mean” (1014): All players who elected this route will compete against each other. The player with, e.g., the highest score that is below the mean wins. The mean is computed, e.g., based on all the tokens of all the players or all of the tokens specific to a given route. The system provides the winner with a reward payout, e.g., 50% of the global pot. In the event of a tie, the payout is distributed in equal amounts to all the winners.
   Route “above mean” (1016): All players who elected this route will compete against each other. A player who has, e.g., the lowest score but above the mean wins. The mean is computed, e.g., based on all the tokens of all the players or all of the tokens specific to a given route. The system provides the winner with a reward payout, e.g., 50% of the global pot. In the event of a tie, the payout is distributed in equal amounts to all the winners.

These examples are non-limited illustrations of a game process managed by the multiplayer wagering game system. The payout amounts, payout conditions, selectable and conditional routing options, fees, route names, among others, are merely illustrative and can be modified without departing from the spirit of the present system.

### Computing Environment

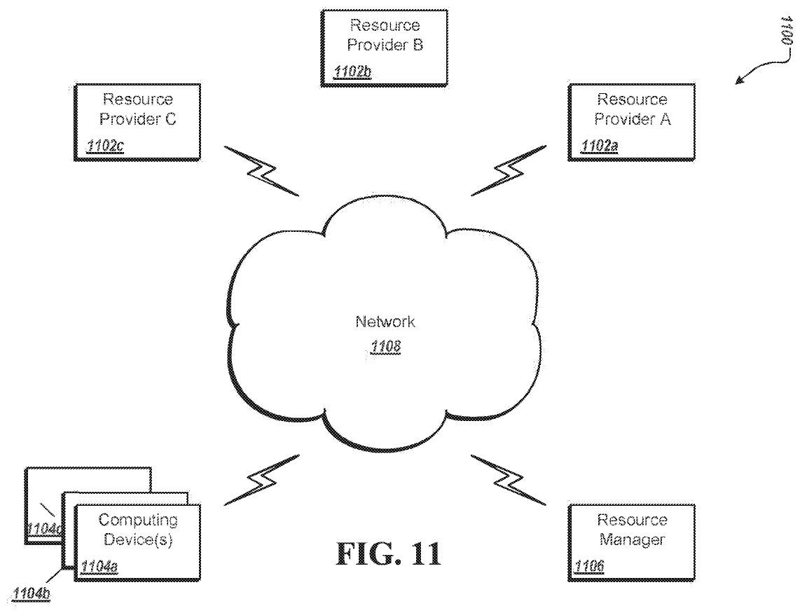

In brief overview, referring now to FIG. 11, a block diagram of an exemplary cloud computing environment 1100 is shown and described. The cloud computing environment 1100 may include one or more resource providers 1102a, 1102b, 1102c (collectively, 1102). Each resource provider 1102 may include computing resources. In some implementations, computing resources may include any hardware and/or software used to process data. For example, computing resources may include hardware and/or software capable of executing algorithms, computer programs, and/or computer applications. In some implementations, exemplary computing resources may include application servers and/or databases with storage and retrieval capabilities. Each resource provider 1102 may be connected to any other resource provider 1102 in the cloud computing environment 1100. In some implementations, the resource providers 1102 may be connected over a computer network 1108. Each resource provider 1102 may be connected to one or more computing device 1104a, 1104b, 1104c (collectively, 1104), over the computer network 1108.

The cloud computing environment 1100 may include a resource manager 1106. The resource manager 1106 may be connected to the resource providers 1102 and the computing devices 1104 over the computer network 1108. In some implementations, the resource manager 1106 may facilitate the provision of computing resources by one or more resource providers 1102 to one or more computing devices 1104. The resource manager 406 may receive a request for a computing resource from a particular computing device 1104. The resource manager 1106 may identify one or more resource providers 1102 capable of providing the computing resource requested by the computing device 1104. The resource manager 1106 may select a resource provider 1102 to provide the computing resource. The resource manager 1106 may facilitate a connection between the resource provider 1102 and a particular computing device 1104. In some implementations, the resource manager 1106 may establish a connection between a particular resource provider 1102 and a particular computing device 1104. In some implementations, the resource manager 1106 may redirect a particular computing device 1104 to a particular resource provider 1102 with the requested computing resource.

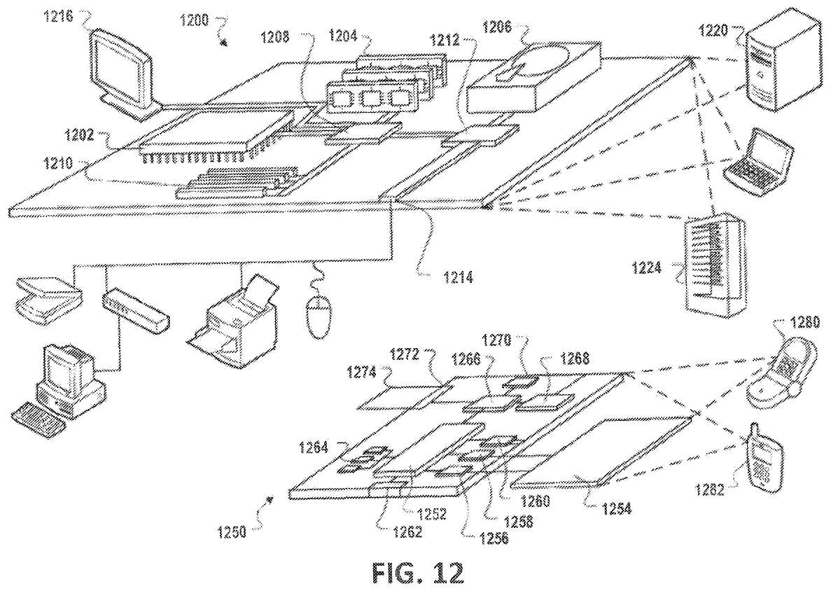

FIG. 12 shows an example of a computing device 1200 and a mobile computing device 1250 that can be used in the methods and systems described in this disclosure. The computing device 1200 is intended to represent various forms of digital computers, such as laptops, desktops, workstations, personal digital assistants, servers, blade servers, mainframes, and other appropriate computers. The mobile computing device 1250 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 1200 includes a processor 1202, a memory 1204, a storage device 1206, a high-speed interface 1208 connecting to the memory 1204 and multiple high-speed expansion ports 1210, and a low-speed interface 1212 connecting to a low-speed expansion port 1214 and the storage device 1206. Each of the processor 1202, the memory 1204, the storage device 1206, the high-speed interface 1208, the high-speed expansion ports 1210, and the low-speed interface 1212, are interconnected using various busses, and may be mounted on a common motherboard or in other manners as appropriate. The processor 1202 can process instructions for execution within the computing device 1200, including instructions stored in the memory 1204 or on the storage device 1206 to display graphical information for a GUI on an external input/output device, such as a display 1216 coupled to the high-speed interface 1208. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 1204 stores information within the computing device 1200. In some implementations, the memory 1204 is a volatile memory unit or units. In some implementations, the memory 1204 is a non-volatile memory unit or units. The memory 1204 may also be another form of computer-readable medium, such as a magnetic or optical disk.

The storage device 1206 is capable of providing mass storage for the computing device 1200. In some implementations, the storage device 1206 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices (for example, processor 1202), perform one or more methods, such as those described above. The instructions can also be stored by one or more storage devices such as computer- or machine-readable mediums (for example, the memory 1204, the storage device 1206, or memory on the processor 1202).

The high-speed interface 1208 manages bandwidth-intensive operations for the computing device 1200, while the low-speed interface 1212 manages lower bandwidth-intensive operations. Such allocation of functions is an example only. In some implementations, the high-speed interface 1208 is coupled to the memory 1204, the display 1216 (e.g., through a graphics processor or accelerator), and to the high-speed expansion ports 1210, which may accept various expansion cards (not shown). In the implementation, the low-speed interface 1212 is coupled to the storage device 1206 and the low-speed expansion port 1214. The low-speed expansion port 1214, which may include various communication ports (e.g., USB, Bluetooth®, Ethernet, wireless Ethernet) may be coupled to one or more input/output devices, such as a keyboard, a pointing device, a scanner, or a networking device such as a switch or router, e.g., through a network adapter.

The computing device 1200 may be implemented in a number of different forms, as shown in the figure. For example, it may be implemented as a standard server 1220, or multiple times in a group of such servers. In addition, it may be implemented in a personal computer such as a laptop computer 1222. It may also be implemented as part of a rack server system 1224. Alternatively, components from the computing device 1200 may be combined with other components in a mobile device (not shown), such as a mobile computing device 1250. Each of such devices may contain one or more of the computing device 1200 and the mobile computing device 1250, and an entire system may be made up of multiple computing devices communicating with each other.

The mobile computing device 1250 includes a processor 1252, a memory 1264, an input/output device such as a display 1254, a communication interface 1266, and a transceiver 1268, among other components. The mobile computing device 1250 may also be provided with a storage device, such as a micro-drive or other device, to provide additional storage. Each of the processor 1252, the memory 1264, the display 1254, the communication interface 1266, and the transceiver 1268, are interconnected using various buses, and several of the components may be mounted on a common motherboard or in other manners as appropriate.

The processor 1252 can execute instructions within the mobile computing device 1250, including instructions stored in the memory 1264. The processor 1252 may be implemented as a chipset of chips that include separate and multiple analog and digital processors. The processor 1252 may provide, for example, for coordination of the other components of the mobile computing device 1250, such as control of user interfaces, applications run by the mobile computing device 1250, and wireless communication by the mobile computing device 1250.

The processor 1252 may communicate with a user through a control interface 1258 and a display interface 1256 coupled to the display 1254. The display 1254 may be, for example, a TFT (Thin-Film-Transistor Liquid Crystal Display) display or an OLED (Organic Light Emitting Diode) display, or other appropriate display technology. The display interface 1256 may comprise appropriate circuitry for driving the display 1254 to present graphical and other information to a user. The control interface 1258 may receive commands from a user and convert them for submission to the processor 1252. In addition, an external interface 1262 may provide communication with the processor 1252, so as to enable near area communication of the mobile computing device 1250 with other devices. The external interface 1262 may provide, for example, for wired communication in some implementations, or for wireless communication in other implementations, and multiple interfaces may also be used.

The memory 1264 stores information within the mobile computing device 1250. The memory 1264 can be implemented as one or more of a computer-readable medium or media, a volatile memory unit or units, or a non-volatile memory unit or units. An expansion memory 1274 may also be provided and connected to the mobile computing device 1250 through an expansion interface 1272, which may include, for example, a SIMM (Single In Line Memory Module) or DIMM (Dual In Line Memory Module) card interface. The expansion memory 1274 may provide extra storage space for the mobile computing device 1250, or may also store applications or other information for the mobile computing device 1250. Specifically, the expansion memory 1274 may include instructions to carry out or supplement the processes described above, and may include secure information also. Thus, for example, the expansion memory 1274 may be provided as a security module for the mobile computing device 1250, and may be programmed with instructions that permit secure use of the mobile computing device 1250. In addition, secure applications may be provided via the SIMM/DIMMcards, along with additional information, such as placing identifying information on the SIMM/DIMM card in a non-hackable manner.

The memory may include, for example, flash memory and/or NVRAM memory (non-volatile random access memory), as discussed below. In some implementations, instructions are stored in an information carrier and, when executed by one or more processing devices (for example, processor 1252), perform one or more methods, such as those described above. The instructions can also be stored by one or more storage devices, such as one or more computer- or machine-readable mediums (for example, the memory 1264, the expansion memory 1274, or memory on the processor 1252). In some implementations, the instructions can be received in a propagated signal, for example, over the transceiver 1268 or the external interface 1262.

The mobile computing device 1250 may communicate wirelessly through the communication interface 1266, which may include digital signal processing circuitry where necessary. The communication interface 1266 may provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 1268 using a radio-frequency. In addition, short-range communication may occur, such as using a Bluetooth®, Wi-Fi™, or other such transceiver (not shown). In addition, a GPS (Global Positioning System) receiver module 1270 may provide additional navigation- and location-related wireless data to the mobile computing device 1250, which may be used as appropriate by applications running on the mobile computing device 1250.

The mobile computing device 1250 may also communicate audibly using an audio codec 1260, which may receive spoken information from a user and convert it to usable digital information. The audio codec 1260 may likewise generate audible sound for a user, such as through a speaker, e.g., in a handset of the mobile computing device 1250. Such sound may include sound from voice telephone calls, may include recorded sound (e.g., voice messages, music files, etc.) and may also include sound generated by applications operating on the mobile computing device 1250.

The mobile computing device 1250 may be implemented in a number of different forms, as shown in the figure. For example, it may be implemented as a cellular telephone 1280. It may also be implemented as part of a smart-phone 1282, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

While the invention has been particularly shown and described with reference to specific preferred embodiments, it should be understood by those skilled in the art that various changes in form and detail may be made therein without departing from the spirit and scope of the invention as defined by the appended claims.

Throughout the description, where apparatus and systems are described as having, including, or comprising specific components, or where processes and methods are described as having, including, or comprising specific steps, it is contemplated that, additionally, there are apparatus, and systems of the present invention that consist essentially of, or consist of, the recited components, and that there are processes and methods according to the present invention that consist essentially of, or consist of, the recited processing steps.

It should be understood that the order of steps or order for performing certain action is immaterial so long as the invention remains operable. Moreover, two or more steps or actions may be conducted simultaneously.

1. A computer-implemented method for operating a multiplayer wagering game system, the method comprising:
receiving, over a network, by a processor of a first computing device, a plurality of player submissions from a plurality of computing devices associated with players in a multiplayer wagering game,
wherein each of the plurality of player submissions includes a member selected from the group consisting of
(a) an incremental wager to a wager pot,
(b) a conditional wager to the wager pot, and
(c) an election of a payout condition associated with the multiplayer wagering game;
grouping, by the processor, each player of the multiplayer wagering game into one of a plurality of playable subgroups within the multiplayer wagering game based on an individual pot associated with each respective player and/or a player submission of the respective player in the plurality of player submissions;
determining, by the processor, ranks of the players in each of the plurality of playable subgroups, by comparing a respective token pattern associated with each player to token patterns of other players in the same playable subgroup; and
causing, by the processor, one or more payouts based on the rank of the players within each playable subgroup.

2. The method of claim 1, comprising:
receiving, by the processor, a plurality of wager submissions for the multiplayer wagering game, wherein each wager submission of the plurality of wager submissions is associated with a given player; and
adding, by the processor, for each of the wager submissions, a player associated with the wager submission to the multiplayer wagering game.

3. The method of claim 2, comprising:
assigning, by the processor, to each player of the multiplayer wagering game, a set of game pieces from a collection of game pieces specific to each player,
wherein the assigned set of game pieces form one or more token patterns according to a ranking system.

4. The method of claim 3, comprising:
assigning, by the processor, a set of community pieces from a collection of community pieces common to all the players,
wherein the assigned set of game pieces specific to a given player and the set of community pieces, collectively, form one or more predefined combinations of the plurality arrangements defined within the ranking system;
responsive to the assignment of the community pieces, determining, by the processor, for each player if any of the assigned game pieces specific to the respective player matches any of the community pieces; and
responsive to each matched game piece and community piece, replacing, by the processor, the matched game piece of the respective player with a substitute game piece selected from the collection of game pieces specific to the player until a non-duplicated community piece is assigned to the player.

5. The method of claim 4, wherein the collection of community pieces is common to all players in the multiplayer wagering game.

6. The method of claim 4, wherein the collection of community pieces is common to all players in a given playable subgroup of the plurality of pre-defined playable subgroups.

7. The method of claim 3, wherein the ranking system is based on poker hand ranks.

8. The method of claim 1, wherein the multiplayer wagering game is based on poker.

9. A computer-implemented method for operating a wagering game system, the method comprising:
for each player of a multiplayer wagering game, during the multiplayer wagering game:
receiving over a network, by a processor of a first computing device, a first player submission from a second computing device associated with a given player, wherein the first player submission includes a wager by the given player to a global wager pot associated with the multiplayer wagering game;
assigning, by the processor, to the given player, a set of first game tokens;
grouping, by the processor, the given player into a subgroup with other players of the multiplayer wagering game based, in part, on a combination form of the set of first game tokens;
assigning, by the processor, to the given player, a set of second game tokens;
comparing, by the processor, combination sets of the assigned set of second game tokens of the given player to combination sets of other players in the subgroup; and
causing, by the processor, one or more payouts based on a rank of the players within the subgroup.

10. The computer-implemented method of claim 9, wherein each of the set of first game tokens and the set of second game tokens comprises a set of tokens corresponding to members selected from the group consisting of playing cards and dice.

11-12. (canceled)

13. A system for operating a wagering game system, the system comprising:
a network;
a processor; and
a memory having instructions thereon, wherein the instructions, when executed by the processor, cause the processor to:
for each player of a multiplayer wagering game, during the multiplayer wagering game:
receive a plurality of player submissions from a plurality of computing devices associated with players in the multiplayer wagering game,
wherein each of the plurality of player submissions includes a member selected from the group consisting of
(a) an incremental wager to a wager pot,
(b) a conditional wager to the wager pot, and
(c) an election of a payout condition associated with the multiplayer wagering game;
group each player of the multiplayer wagering game into one of a plurality of playable subgroups within the multiplayer wagering game based on an individual pot associated with each respective player and/or a player submission of the respective player in the plurality of player submissions;
determine ranks of the players, in each of the plurality of pre defined playable subgroups, by comparing a respective token pattern associated with each player to token patterns of other players in the same playable subgroup; and
cause one or more payouts based on the rank of the players within each playable subgroup.

14. The system of claim 13, wherein the instructions, when executed by the processor, cause the processor to:
receive a plurality of wager submissions for the multiplayer wagering game, wherein each wager submission of the plurality of wager submissions is associated with a given player; and
add for each of the plurality of wager submissions, a player associated with the submission to the multiplayer wagering game.

15. The system of claim 14, wherein the instructions, when executed by the processor, cause the processor to:
assign, to each player of the multiplayer wagering game, a set of game pieces from a collection of game pieces specific to each player, wherein the assigned set of game pieces form one or more token patterns according to a ranking system

16. The system of claim 15, wherein the instructions, when executed by the processor, cause the processor to:
assign, a set of community pieces from a collection of community pieces common to all the players,
wherein the assigned set of game pieces specific to a given player and the set of community pieces, collectively, form one or more predefined combinations of the plurality arrangements defined within the ranking system; and
responsive to the assignment of the community pieces, determine for each player if any of the assigned game pieces specific to the respective player matches any of the community pieces; and
responsive to each matched game piece and community piece, replace, the matched game piece of the player with a substitute game piece selected from the collection of game pieces specific to the player until a non-duplicated community piece is assigned to the player.

17. The system of claim 16, wherein the collection of community pieces is common to all players in the multiplayer wagering game.

18. The system of claim 16, wherein the collection of community pieces is common to all players in a given playable subgroup of the plurality of pre-defined playable subgroups.

19. The system of claim 15, wherein the ranking system is based on poker hand ranks.

20. The system of claim 13, wherein the multiplayer wagering game is based on poker.

21-22. (canceled)
